(19) United States
(12) Patent Application Publication
(10) Pub. No.: US 2018/0030376 A1
(43) Pub. Date: Feb. 1, 2018

(54) Cleaning Articles Comprising Cleaning Agents

(71) Applicant: The Procter & Gamble Company, Cincinnati, OH (US)

(72) Inventors: Cahit Eylem, West Chester, OH (US); Michael ScottP Prodoehl, West Chester, OH (US); David Dale McKay, Wilmington, OH (US); Elizabeth Ann Hackbarth, Cincinnati, OH (US); Robert Joseph McChain, Cincinnati, OH (US); Robin Lynn McKiernan, Mason, OH (US); Linda Evers Smith, Morrow, OH (US); Steven Daryl Smith, Fairfield, OH (US); Seth Edward Lindberg, Cincinnati, OH (US); Matthew Gary McKee, Cincinnati, OH (US)

(21) Appl. No.: 15/661,189

(22) Filed: Jul. 27, 2017

Related U.S. Application Data
(60) Provisional application No. 62/367,232, filed on Jul. 27, 2016.

(51) Int. Cl. C11D 1/00; C11D 1/86; A47L 13/17; C11D 17/04

(52) U.S. Cl. CPC C11D 1/008; C11D 17/049; C11D 1/86; A47L 13/17

(57) ABSTRACT

A cleaning article including one or more cleaning agents such that the cleaning article exhibits improved mirror cleaning.

### FIELD OF THE INVENTION

The present disclosure generally relates to cleaning articles, for example fibrous structures, such as paper towels, comprising one or more cleaning agents for cleaning surfaces.

### BACKGROUND OF THE INVENTION

In the past, cleaning articles, such as paper towels, have been commonly utilized in combination with liquid cleaning compositions to clean windows, mirrors, countertops, and other hard surfaces. Known cleaning articles typically provide cleaning performance primarily by absorption of soil laden fluid, consequently, the cleaning performance of known cleaning articles is limited by the ability of the cleaning articles to absorb and retain the soil laden fluid.

Improved removal of soil from various surfaces continues to be a big consumer need. Formulators have attempted to enhance the soil removal properties of known cleaning articles by incorporating cleaning agents into liquid cleaning compositions. There are known liquid cleaning compositions, such as liquid spray cleaners, that comprise a cleaning agent, for example a Mirapol® polymer (a copolymer of an acrylic acid (an anionic monomeric unit) and a diquaternary ammonium compound (a cationic monomeric unit)) available from Rhodia and/or a polyacrylamide polymer (nonionic monomeric units), such as a Hyperfioc® polymer available from Hychem Inc. and/or a Lupasol® polymer (a polyethyleneimine (cationic monomeric units)) available from BASF Corporation, that are designed to aid in the removal of soil from various surfaces when applied to the surface in a liquid form.

One problem faced by formulators is that consumers desire improved surface cleaning properties, for example mirror cleaning properties and/or soil adsorption properties, from cleaning articles compared to such properties from known cleaning articles. The problem faced by formulators is how to retain or substantially retain the “fresh” or “unaged” performance of cleaning agents present on the cleaning articles such that even after being subjected to the Accelerated Aging Procedure described herein the cleaning articles retain at least 50% of the initial average Mirror Cleaning Densitometer Value as measured according to the Mirror Cleaning Test Method after the cleaning article has been subjected to the Accelerated Aging Procedure described herein and/or exhibits an average Mirror Cleaning Densitometer Value of greater than −0.55 as measured according to the Mirror Cleaning Test Method after the cleaning article has been subjected to the Accelerated Aging Procedure described herein.

Accordingly, there still exists a need for a cleaning article that exhibits enhanced cleaning properties, for example surface cleaning properties, such as mirror cleaning properties and soil adsorption properties, compared to known cleaning articles.

### SUMMARY OF THE INVENTION

The present invention fulfills the need described above by providing a cleaning article, for example a fibrous structure, such as a paper towel, comprising one or more cleaning agents, for example on one or more surfaces of the cleaning article such that one or more of the cleaning agents contacts a surface in need of cleaning during use at least 50% of the cleaning article's initial average Mirror Cleaning Densitometer Value as measured according to the Mirror Cleaning Test Method after the cleaning article has been subjected to the Accelerated Aging Procedure described herein and/or exhibits an average Mirror Cleaning Densitometer Value of greater than −0.55 as measured according to the Mirror Cleaning Test Method after the cleaning article has been subjected to the Accelerated Aging Procedure described herein.

One solution to the problem identified above is to provide cleaning articles that comprise one or more film cleaning agents that comprise two or more monomeric units selected from the group consisting of nonionic monomeric units, anionic monomeric units, and/or cationic monomeric units such that the cleaning articles retains at least 50% of the initial average Mirror Cleaning Densitometer Value as measured according to the Mirror Cleaning Test Method after the cleaning article has been subjected to the Accelerated Aging Procedure described herein and/or exhibits an average Mirror Cleaning Densitometer Value of greater than −0.55 as measured according to the Mirror Cleaning Test Method described herein after the cleaning article has been subjected to the Accelerated Aging Procedure described herein.

In one example of the present invention, a cleaning article, for example a fibrous structure, such as a paper towel, comprises one or more film cleaning agents, for example on one or more surfaces of the cleaning article such that one or more of the film cleaning agents contacts a surface, such as a mirror, in need of cleaning during use. The soil capture agent comprises a film-forming polymer. The film-forming polymer comprises two or more monomeric units selected from the group consisting of nonionic monomeric units, anionic monomeric units, and/or cationic monomeric units. The film-forming polymer comprises at least one monomeric unit selected from group a and at least one monomeric unit selected from groups b and c. At least a portion of the cleaning article retains at least 50% of the initial average Mirror Cleaning Densitometer Value as measured according to the Mirror Cleaning Test Method after the cleaning article has been subjected to the Accelerated Aging Procedure described herein and/or exhibits an average Mirror Cleaning Densitometer Value of greater than −0.55 as measured according to the Mirror Cleaning Test Method described herein after the cleaning article has been subjected to the Accelerated Aging Procedure described herein.

In another example of the present invention, a cleaning article for example a fibrous structure, such as a paper towel, comprises one or more film cleaning agents, for example on one or more surfaces of the cleaning article such that one or more of the film cleaning agents contacts a surface, such as a mirror, in need of cleaning during use. The soil capture agent comprises a film-forming polymer. The film-forming polymer comprises two or more monomeric units selected from the group consisting of nonionic monomeric units, anionic monomeric units, and/or cationic monomeric units. The film-forming polymer comprises at least one monomeric unit selected from group a and at least one monomeric unit selected from groups b and c wherein the monomeric units are present in the film-forming polymer at a molar ratio of from about 3:1 to about 1:3.

In another example of the present invention, a method for making a cleaning article, for example a fibrous structure, such as a paper towel, wherein the method comprises the steps of:

a. providing a cleaning article, for example a fibrous structure, such as a paper towel; and

b. applying one or more film cleaning agents to the cleaning article such that the cleaning article exhibits an average Mirror Cleaning Densitometer Value of greater than −0.55 as measured according to the Mirror Cleaning Test Method after the cleaning article has been subjected to the Accelerated Aging Procedure described herein, is provided.

In another example of the present invention, a method for making a cleaning article, for example a fibrous structure, such as a paper towel, wherein the method comprises the steps of:

a. providing a cleaning article, for example a fibrous structure, such as a paper towel; and

b. applying two or more cleaning agents to the cleaning article such that the cleaning article exhibits an average Mirror Cleaning Densitometer Value of greater than −0.55 as measured according to the Mirror Cleaning Test Method after the cleaning article has been subjected to the Accelerated Aging Procedure described herein, is provided.

In another example of the present invention, a method for making a cleaning article, for example a fibrous structure, such as a paper towel, wherein the method comprises the steps of:

a. providing a cleaning article, for example a fibrous structure, such as a paper towel; and

b. applying one or more film cleaning agents to the cleaning article such that the cleaning article retains at least 50% of the initial average Mirror Cleaning Densitometer Value as measured according to the Mirror Cleaning Test Method after the cleaning article has been subjected to the Accelerated Aging Procedure described herein, is provided.

In another example of the present invention, a method for making a cleaning article, for example a fibrous structure, such as a paper towel, wherein the method comprises the steps of:

a. providing a cleaning article, for example a fibrous structure, such as a paper towel; and

b. applying two or more cleaning agents to the cleaning article such that the cleaning article retains at least 50% of the initial average Mirror Cleaning Densitometer Value as measured according to the Mirror Cleaning Test Method after the cleaning article has been subjected to the Accelerated Aging Procedure described herein, is provided.

In yet another example of the present invention, a method for cleaning a mirror, the method comprises the steps of:

a. providing a cleaning article, for example a fibrous structure, such as a paper towel, according to the present invention; and

b. contacting a mirror to be cleaned with the cleaning article such that the cleaning article exhibits an average Mirror Cleaning Densitometer Value of greater than −0.55 as measured according to the Mirror Cleaning Test Method after the cleaning article has been subjected to the Accelerated Aging Procedure described herein, is provided.

In yet another example of the present invention, a method for cleaning a mirror, the method comprises the steps of:

a. providing a cleaning article, for example a fibrous structure, such as a paper towel, according to the present invention; and

b. contacting a mirror to be cleaned with the cleaning article such that the cleaning article retains at least 50% of the initial average Mirror Cleaning Densitometer Value as measured according to the Mirror Cleaning Test Method after the cleaning article has been subjected to the Accelerated Aging Procedure described herein, is provided.

The present invention provides a cleaning article, for example a fibrous structure, such as a paper towel, comprising one or more film cleaning agents such that the cleaning article exhibits improved mirror cleaning compared to known cleaning articles especially after the cleaning article has been subjected to the Accelerated Aging Procedure described herein, a method for making such a cleaning article, and a method for cleaning a mirror with such a cleaning article.

### BRIEF DESCRIPTION OF THE DRAWINGS

FIG. 1 is a schematic representation of a sample of cleaning article used in the Mirror Cleaning Test Method described herein;

FIG. 2 is a schematic representation of 9 individual spectrodensitometer measurement spots on a surface of a mirror for the Mirror Cleaning Test Method;

### DETAILED DESCRIPTION OF THE INVENTION

### Definitions

“Cleaning Article” as used herein means is any solid matter, such as a web, sponge, foam structure, co-form material, fibrous structure, or particle. In one example, such cleaning articles may comprise paper towels. In another example, such cleaning articles may comprise floor cleaning pads. In one example, the cleaning article is a dry cleaning article. In one example, at least a portion of the cleaning article exhibits a basis weight of about 150 gsm or less and/or about 100 gsm or less and/or from about 30 gsm to about 95 gsm. In one example, the cleaning article comprises a material formed of cotton such that at least a portion of the cleaning article comprises excess anionic charge.

“Dry cleaning article” as used herein means that the cleaning article includes less than about 30% and/or, less than about 20% and/or less than 10% and/or less than 5% and/or less than 3% and/or less than 2% and/or less than 1% and/or less than 0.5% by weight of moisture as measured according to the Moisture Content Test Method described herein.

“Monomeric unit” as used herein is a constituent unit (sometimes referred to as a structural unit) of a polymer.

“Nonionic monomer” as used herein means a monomer that exhibits no net charge at a pH of 7 and/or is identified as a nonionic monomer herein.

“Nonionic monomeric unit” as used herein means a monomeric unit that exhibits no net charge at a pH of 7 and/or is identified as a nonionic monomeric unit herein. A nonionic monomeric unit may be derived from nonionic monomer.

“Anionic monomer” as used herein means a monomer that exhibits a net negative charge at a pH of 7 and/or is identified as an anionic monomer herein. An anionic monomer is generally associated with one or more cations such as protons or cations of alkali metal or alkaline earth metal, for example sodium of cationic groups such as ammonium.

“Anionic monomeric unit” as used herein means a monomeric unit that exhibits a net negative charge at a pH of 7 and/or is identified as an anionic monomeric unit herein. An anionic monomeric unit may be derived from an anionic monomer. An anionic monomeric unit is generally associated with one or more cations such as protons or cations of alkali metal or alkaline earth metal, for example sodium of cationic groups such as ammonium.

“Cationic monomer” as used herein means a monomer that exhibits a net positive charge at a pH of 7 and/or is identified as a cationic monomer herein. A cationic monomer is generally associated with one or more anions such as a chloride ion, a bromide ion, a sulfonate group and/or a methyl sulfate group.

“Cationic monomeric unit” as used herein means a monomeric unit that exhibits a net positive charge at a pH of 7 and/or is identified as a cationic monomeric unit herein. A cationic monomeric unit is generally associated with one or more anions such as a chloride ion, a bromide ion, a sulfonate group and/or a methyl sulfate group.

“Basis Weight” as used herein is the weight per unit area of a sample reported in gsm and is measured according to the Basis Weight Test Method described herein.

“Fiber” and/or “Filament” as used herein means an elongate particulate having an apparent length greatly exceeding its apparent width, i.e. a length to diameter ratio of at least about 10. In one example, a “fiber” is an elongate particulate that exhibits a length of less than 5.08 cm (2 in.) and a “filament” is an elongate particulate that exhibits a length of greater than or equal to 5.08 cm (2 in.).

“Fibrous structure” as used herein means a structure that comprises one or more fibrous filaments and/or fibers. In one example, a fibrous structure according to the present invention means an orderly arrangement of filaments and/or fibers within a structure in order to perform a function. Non-limiting examples of fibrous structures can include paper, fabrics (including woven, knitted, and non-woven), and absorbent pads (for example for diapers or feminine hygiene products).

“Film” refers to a sheet-like material wherein the length and width of the material far exceed the thickness of the material.

“Hard surface” refers to any kind of surfaces typically found in and around houses like bathrooms, kitchens, basements and garages, e.g., floors, walls, tiles, windows, countertops, sinks, showers, shower plastified curtains, wash basins, WCs, dishes, fixtures and fittings and the like made of different materials like ceramic, enamel, painted and un-painted concrete, plaster, bricks, vinyl, no-wax vinyl, linoleum, melamine, Formica®, glass, any plastics, metals, chromed surface and the like. The term surfaces as used herein also include household appliances including, but not limited to, washing machines, automatic dryers, refrigerators, freezers, ovens, microwave ovens, dishwashers and so on.

“Hydrophilic” and “Hydrophobic” As used herein, the term “hydrophilic” is used to refer to surfaces that are wettable by aqueous fluids deposited thereon. Hydrophilicity and wettability are typically defined in terms of contact angle and the surface tension of the fluids and surfaces involved. This is discussed in detail in the American Chemical Society publication entitled Contact Angle, Wettability and Adhesion, edited by Robert F. Gould (Copyright 1964) which is hereby incorporated by reference. A surface is said to be wetted by an aqueous fluid (hydrophilic) when the fluid tends to spread spontaneously across the surface. Conversely, a surface is considered to be “hydrophobic” if the aqueous fluid does not tend to spread spontaneously across the surface.

“Number average molecular weight” as used herein means the number average molecular weight Mₙ as determined using gel permeation chromatography.

“Paper product” refers to any formed fibrous structure product, which may, but not necessarily, comprise cellulose fibers. In one embodiment, the paper products of the present disclosure include tissue-towel paper products.

“Polydispersity Index” or “PDI” as used herein means the ratio of the weight average molecular weight to the number average molecular weight, M_{w}/Mₙ, as determined using gel permeation chromatography.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels), and folded sanitary tissue products such as napkins and/or facial tissues including folded sanitary tissue products dispensed from a container, such as a box. The sanitary tissue product may be convolutedly wound upon itself about a core or without a core to form a sanitary tissue product roll.

“Soil” refers to organic or inorganic material, often particulate in nature that may include dirt, clays, food particulates, sebum or greasy residue, soot, etc.

“Tissue-towel paper product” as used herein refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Web” as used herein means a fibrous structure or a film.

“Fibrous structure” as used herein means a structure that comprises one or more fibrous filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid processes, such as wet-laid papermaking processes, and air-laid processes, such as air-laid papermaking processes. Wet-laid and/or air-laid papermaking processes and/or air-laid papermaking processes typically include a step of preparing a composition comprising a plurality of fibers that are suspended in a medium, either wet, more specifically aqueous medium, or dry, more specifically gaseous medium, such as air. The aqueous medium used for wet-laid processes is oftentimes referred to as a fiber slurry. The fiber composition is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

Another process that can be used to produce the fibrous structures is a melt-blowing and/or spunbonding process where a polymer composition is spun into filaments and collected on a belt to produce a fibrous structure. In one example, a plurality of fibers may be mixed with the filaments prior to collecting on the belt and/or a plurality of fibers may be deposited on a prior produced fibrous structure comprising filaments. The fibrous structures of the present invention may be homogeneous or may be layered in the direction normal to the machine direction. If layered, the fibrous structures may comprise at least two and/or at least three and/or at least four and/or at least five layers. The fibrous structures of the present invention may be co-formed fibrous structures.

“Co-formed” as used herein means that the fibrous structure comprises a mixture of at least two different components wherein at least one of the components comprises a filament, such as a polypropylene filament, and at least one other component, different from the first component, comprises a solid additive, such as a fiber and/or a particulate. In one example, a co-formed fibrous structure comprises solid additives, such as fibers, such as wood pulp fibers and/or absorbent gel articles of manufacture and/or filler particles and/or particulate spot bonding powders and/or clays, and filaments, such as polypropylene filaments.

“Weight average molecular weight” as used herein means the weight average molecular weight M_{w} as determined using gel permeation chromatography.

“Cleaning agent” as used herein means a material, for example a polymer, that comprises one or more monomeric units and/or two or more monomeric units and/or three or more monomeric units selected from the group consisting of: nonionic monomeric units, anionic monomeric units, cationic monomeric units, and mixtures thereof. In one example, the cleaning agent comprises a homopolymer, for example a homopolymer comprising a single nonionic monomeric unit, a homopolymer comprising a single anionic monomeric unit, and/or a homopolymer comprising a single cationic monomeric unit. In another example, the cleaning agent comprises a copolymer, for example a copolymer comprising a nonionic monomeric unit and an anionic monomeric unit and/or a copolymer comprising a nonionic monomeric unit and a cationic monomeric unit. In still another example, the cleaning agent comprises a terpolymer comprising a nonionic monomeric unit, an anionic monomeric unit, and a cationic monomeric unit.

In another example, the cleaning article of the present invention comprise two or more cleaning agents, for example a blend or mixture of two or more cleaning agents and/or as individual components present on a surface of the cleaning article so long as the cleaning agents comprise polymers comprising nonionic monomeric units, anionic monomeric units, and cationic monomeric units. For example, a cleaning article of the present invention, for example the cleaning article's surface, may comprise a first cleaning agent comprising a copolymer comprising a nonionic monomeric unit and an anionic monomeric unit and a second cleaning agent comprising copolymer comprising a nonionic monomeric unit and a cationic monomeric unit. In another example, a cleaning article of the present invention, for example the cleaning article's surface, may comprise a first cleaning agent comprising a terpolymer, for example acrylamide/DADMAC/acrylic acid, and a second cleaning agent comprising a homopolymer, for example polyDADMAC. In yet another example, a cleaning article of the present invention, for example the cleaning article's surface, may comprise a first cleaning agent comprising a first terpolymer, for example acrylamide/DADMAC/acrylic acid, and a second cleaning agent comprising a second terpolymer, for example acrylamide/MAPTAC/acrylic acid. In even another example, a cleaning article of the present invention, for example the cleaning article's surface, may comprise a first cleaning agent comprising a terpolymer, for example acrylamide/DADMAC/acrylic acid, and a second cleaning agent comprising a copolymer, for example acrylamide/acrylic acid. In even yet another example, a cleaning article of the present invention, for example the cleaning article's surface, may comprise a first cleaning agent comprising a copolymer, for example acrylamide/acrylic acid, and a second cleaning agent comprising a homopolymer, for example polyDADMAC. In still another example, a cleaning article of the present invention, for example the cleaning article's surface, may comprise a first cleaning agent comprising a first homopolymer, for example polyacrylamide, a second cleaning agent comprising a second homopolymer, for example polyacrylic acid, and a third cleaning agent, for example polyDADMAC.

In one example, the different cleaning agents may be present on the surface of the cleaning article at weight ratios of 3:1 to 1:3 and/or 2:1 to 1:2 and/or 1:1 with respect to any two of the two or more cleaning agents.

In one example, the blend of two or more cleaning agents comprises a % solids (total active film-forming polymer) of from about 2% to about 30% and/or from about 2% to about 25% and/or from about 2% to about 20% so long as the blend avoids becoming an inactive coacervate.

In one example, the blend of two or more cleaning agents exhibits a pH, for example of about 4, prior to application to a cleaning article, for example a fibrous structure, such as a paper towel, such that the pH of the blend does not increase upon being deposited onto a cleaning article, for example a cleaning article exhibiting a pH of greater than 7, resulting in the blend becoming a coacervate, which may be an inactive coacervate.

Before the blends become a coacervate, the blends may go through a hydrogel phase, which may be an acceptable form for the cleaning agents on the cleaning article to achieve mirror cleaning and/or soil adsorption properties.

“Film cleaning agent” as used herein means the polymers of the cleaning agents are in film form, not particle form. In other words, the film cleaning agents of the present invention are not present nor are they visible as particles on a surface of the cleaning article of the present invention. The polymers of the film cleaning agents are film-forming polymers and once applied to a surface of a cleaning article form a film, not a particle. Further, in one example, the film-forming polymers of the present invention are water-soluble film-forming polymers. The film-forming polymers of the present invention may be random copolymers. In one example, the film-forming polymers of the present invention may be water-soluble and/or water-dispersible, which means that the film-forming polymer does not, over at least a certain pH and concentration range, form a two-phase composition in water at 23° C.±2.2° C. and a relative humidity of 50%±10%.

### Cleaning Agents and Film-Forming Polymers

A cleaning agent as described herein provides enhanced benefits in mirror cleaning and optionally, soil adsorption.

In one example, the cleaning agents of the present invention comprise one or more film-forming polymers such that a cleaning article comprising the cleaning agents exhibits an average Mirror Cleaning Densitometer Value of greater than −0.55 and/or greater than −0.51 and/or greater than −0.48 and/or greater than −0.46 and/or greater than −0.45 and/or greater than −0.40 and/or greater than −0.35 and/or greater than −0.30 and/or greater than −0.25 as measured according to the Mirror Cleaning Test Method described herein after the cleaning article has been subjected to the Accelerated Aging Procedure described herein.

In one example, the cleanings of the present invention comprise one or more film-forming polymer such that a cleaning article comprising the cleaning agents retains at least 50% and/or at least 55% and/or at least 60% and/or at least 65% and/or at least 70% and/or at least 75% to about 100% and/or to about 95% and/or to about 90% of the initial average Mirror Cleaning Densitometer Value as measured according to the Mirror Cleaning Test Method described herein after the cleaning article has been subjected to the Accelerated Aging Procedure described herein.

In one example, the cleaning agents of the present invention comprise one or more film-forming polymers that exhibit a Number Average Molecular Weight of less than 2,000,000 g/mol and/or less than 1,750,000 g/mol and/or less than 1,700,000 g/mol and/or less than 1,500,000 g/mol and/or greater than 500,000 g/mol and/or greater than 900,000 g/mol. In another example, the film-forming polymers exhibit a Number Average Molecular Weight of from about 500,000 to 2,000,000 g/mol and/or from about 900,000 to 1,700,000 g/mol.

In another example, the cleaning agents of the present invention comprises one or more film-forming polymers such that the cleaning article comprising the cleaning agents exhibits a Soil Adsorption Value of greater than 90 and/or greater than 110 and/or greater than 120 and/or greater than 150 and/or greater than 175 and/or greater than 180 and/or greater than 200 mg soil/g cleaning article as measured according to the Soil Adsorption Test Method described herein.

In yet another example, the cleaning agents comprise one or more film-forming polymers that exhibit an excess charge (charge density at pH 4.5) of from about −0.1 meq/g and/or from about −0.05 meq/g and/or from about −0.02 meq/g and/or from about 0 meq/g and/or to about +0.1 meq/g and/or to about +0.09 meq/g and/or to about +0.08 meq/g and/or to about +0.06 meq/g and/or to about +0.05 meq/g and/or to about +0.02 meq/g as measured according to the Charge Density Test Method described herein. In still another example, the film-forming polymers of the present invention exhibit a charge density of from about −0.1 meq/g to about +0.1 meq/g and/or from −0.05 meq/g to about +0.1 meq/g and/or from about 0 to less than +0.1 meq/g and/or to less than +0.09 meq/g and/or to less than +0.08 meq/g and/or to less than +0.06 meq/g and/or to less than +0.05 meq/g as measured according to the Charge Density Test Method described herein. In one example, the film-forming polymers of the present invention exhibit an excess charge (charge density) of from about 0 to about 0.1 meq/g. In another example, the polymers of the present invention exhibit an excess charge (charge density) of about 0.05 meq/g or less.

In another example, the cleaning agents comprise one or more film-forming polymers that exhibit a Polydispersity Index of less than 2.5 and/or of less than 2.0 and/or less than 1.7 and/or less than 1.5 and/or less than 1.3.

In one example, a cleaning agent of the present invention comprises a film-forming polymer comprising one or more monomeric units selected from the group consisting of: a. nonionic monomeric units; b. anionic monomeric units; c. cationic monomeric units; and e. mixtures thereof.

In one example, a cleaning agent of the present invention comprises a film-forming polymer comprising two or more monomeric units selected from the group consisting of: a. nonionic monomeric units; b. anionic monomeric units; c. cationic monomeric units; d. zwitterionic monomeric units; and e. mixtures thereof.

a. Nonionic Monomeric Units

The nonionic monomeric units may be selected from the group consisting of: nonionic hydrophilic monomeric units, nonionic hydrophobic monomeric units, and mixtures thereof.

Non-limiting examples of nonionic hydrophilic monomeric units suitable for the present invention include nonionic hydrophilic monomeric units derived from nonionic hydrophilic monomers selected from the group consisting of: hydroxyalkyl esters of α,β-ethylenically unsaturated acids, such as hydroxyethyl or hydroxypropyl acrylates and methacrylates, glyceryl monomethacrylate, α,β-ethylenically unsaturated amides such as acrylamide (AAM), N,N-diemthylacrylamide (NDMAAM), N,N-dimethylmethacrylamide, N-methylolacrylamide, α,β-ethylenically unsaturated monomers bearing a water-soluble polyoxyalkylene segment of the poly(ethylene oxide) type, such as poly(ethylene oxide) α-methacrylates (Bisomer S20W, S10W, etc., from Laporte) or α,ω-dimethacrylates, Sipomer BEM from Rhodia (ω-behenyl polyoxyethylene methacrylate), Sipomer SEM-25 from Rhodia (w-tristyrylphenyl polyoxyethylene methacrylate), α,β-ethylenically unsaturated monomers which are precursors of hydrophilic units or segments, such as vinyl acetate, which, once polymerized, can be hydrolyzed in order to give rise to vinyl alcohol units or polyvinyl alcohol segments, vinylpyrrolidones, α,β-ethylenically unsaturated monomers of the ureido type, and in particular 2-imidazolidinone-ethyl methacrylamide (Sipomer WAM II from Rhodia), and mixtures thereof. In one example, the nonionic hydrophilic monomeric unit is derived from acrylamide.

Non-limiting examples of nonionic hydrophobic monomeric units suitable for the present invention include nonionic hydrophobic monomeric units derived from nonionic hydrophobic monomers selected from the group consisting of: vinylaromatic monomers such as styrene, alpha-methylstyrene, vinyltoluene, vinyl halides or vinylidene halides, such as vinyl chloride, vinylidene chloride, C₁-C₁₂ alkylesters of α,β-monoethylenically unsaturated acids such as methyl, ethyl or butyl acrylates and methacrylates, 2-ethylhexyl acrylate, vinyl esters or allyl esters of saturated carboxylic acids, such as vinyl or allyl acetates, propionates, versatates, stearates, α,β-monoethylenically unsaturated nitriles containing from 3 to 12 carbon atoms, such as acrylonitrile, methacrylonitrile, α-olefins such as ethylene, conjugated dienes, such as butadiene, isoprene, chloroprene, and mixtures thereof.

b. Anionic Monomeric Units

Non-limiting examples of anionic monomeric units suitable for the present invention include anionic monomeric units derived from anionic monomers selected from the group consisting of: monomers having at least one carboxylic function, for instance α,β-ethylenically unsaturated carboxylic acids or the corresponding anhydrides, such as acrylic acid (AA), methacrylic acid, or maleic acid or anhydrides of such acids, fumaric acid, itaconic acid, N-methacroylalanine, N-acryloylglycine, and their water-soluble salts, monomers that are precursors of carboxylate functions, such as tert-butyl acrylate, which, after polymerization, give rise to carboxylic functions by hydrolysis, monomers having at least one sulfate or sulfonate function, such as 2-sulfooxyethyl methacrylate, vinylbenzene sulfonic acid, allyl sulfonic acid, 2-acrylamido-2-methylpropane sulfonic acid (AMPS), sulfoethyl acrylate or methacrylate, sulfopropyl acrylate or methacrylate, and their water-soluble salts, monomers having at least one phosphonate or phosphate function, such as vinylphosphonic acid, etc., the esters of ethylenically unsaturated phosphates, such as the phosphates derived from hydroxyethyl methacrylate (Empicryl 6835 from Rhodia) and those derived from polyoxyalkylene methacrylates, and their water-soluble salts, and 2-carboxyethyl acrylate (CEA), and mixtures thereof. In one example, the anionic monomeric unit is derived from an anionic monomer selected from the group consisting of: acrylic acid, AMPS, CEA, and mixtures thereof. In another example, the anionic monomeric unit is derived from acrylic acid.

c. Cationic Monomeric Units

Non-limiting examples of cationic monomeric units suitable for the present invention include cationic monomeric units derived from cationic monomers selected from the group consisting of: N,N-(dialkylamino-ω-alkyl)amides of α,β-monoethylenically unsaturated carboxylic acids, such as N,N-dimethylaminomethylacrylamide or -methacrylamide, 2-(N,N-dimethylamino)ethylacrylamide or -methacrylamide, 3-(N,N-dimethylamino)propylacrylamide or -methacrylamide, and 4-(N,N-dimethylamino)butylacrylamide or -methacrylamide, α,β-monoethylenically unsaturated amino esters such as 2-(dimethylamino)ethyl acrylate (DMAA), 2-(dimethylamino)ethyl methacrylate (DMAM), 3-(dimethylamino)propyl methacrylate, 2-(tert-butylamino)ethyl methacrylate, 2-(dipentylamino)ethyl methacrylate, and 2(diethylamino)ethyl methacrylate, vinylpyridines, vinylamine, vinylimidazolines, monomers that are precursors of amine functions such as N-vinylformamide, N-vinylacetamide, which give rise to primary amine functions by simple acid or base hydrolysis, acryloyl- or acryloyloxyammonium monomers such as trimethylammonium propyl methacrylate chloride, trimethylammonium ethylacrylamide or -methacrylamide chloride or bromide, trimethylammonium butylacrylamide or -methacrylamide methyl sulfate, trimethylammonium propylmethacrylamide methyl sulfate, (3-methacrylamidopropyl)trimethylammonium chloride (MAPTAC), (3-methacrylamidopropyl)trimethylammonium methyl sulphate (MAPTA-MES), (3-acrylamidopropyl)trimethylammonium chloride (APTAC), methacryloyloxyethyl-trimethylammonium chloride or methyl sulfate, and acryloyloxyethyltrimethylammonium chloride; 1-ethyl-2-vinylpyridinium or 1-ethyl-4-vinylpyridinium bromide, chloride or methyl sulfate; N,N-dialkyldiallylamine monomers such as N,N-dimethyldiallylammonium chloride (DADMAC); polyquaternary monomers such as dimethylaminopropylmethacrylamide chloride and N-(3-chloro-2-hydroxypropyl)trimethylammonium (DIQUAT or DQ) and 2-hydroxy-N¹-(3-(2((3-methacrylamidopropyl)dimethylammino)-acetamido)propyl)-N¹, N¹, N³, N³, N³-pentamethylpropane-1,3-diaminium chloride (TRIQUAT or TQ), and mixtures thereof. In one example, the cationic monomeric unit comprises a quaternary ammonium monomeric unit, for example a monoquaternary ammonium monomeric unit, a diquaternary ammonium monomeric unit and a triquaternary monomeric unit. In one example, the cationic monomeric unit is derived from MAPTAC. In another example, the cationic monomeric unit is derived from DADMAC. In still another example, the cationic monomeric unit is derived from TQ.

In one example, the cationic monomeric units are derived from cationic monomers selected from the group consisting of: dimethylaminoethyl (meth)acrylate, dimethylaminopropyl (meth)acrylate, di-tert-butylaminoethyl (meth)acrylate, dimethylaminomethyl (meth)acrylamide, dimethylaminopropyl (meth)acrylamide, ethylenimine, vinylamine, 2-vinylpyridine, 4-vinylpyridine and vinyl imidazole, and mixtures thereof.

In another example, the cationic monomeric units are derived from cationic monomers selected from the group consisting of: trimethylammonium ethyl (meth)acrylate bromide, chloride or methyl sulfate, trimethylammonium ethyl (meth)acrylate bromide, chloride or methyl sulfate, trimethylammonium ethyl (meth)acrylate bromide, chloride or methyl sulfate, dimethylaminoethyl (meth)acrylate benzyl chloride, 4-benzoylbenzyl dimethylammoniumethyl (meth)acrylate bromide, chloride or methyl sulfate, trimethylammonium ethyl (meth)acrylamido bromide, chloride, or methyl sulfate, trimethylammonium propyl (meth)acrylamido braomide, chloride, or methyl sulfate, vinyl benzyl trimethyl ammonium bromide, chloride or methyl sulfate, diallyldimethyl ammonium chloride, 1-ethyl-2-vinylpyridinium bromide, chloride or methyl sulfate, 4-vinylpyridinium bromide, chloride or methyl sulfate, and mixtures thereof.

d. Zwitterionic Monomeric Units

Non-limiting examples of zwitterionic monomeric units suitable for the present invention include zwitterionic monomeric units derived from zwitterionic monomers selected from the group consisting of: sulfobetaine monomers, such as sulfopropyl dimethylammonium ethyl methacrylate (SPE from Raschig), sulfopropyldimethylammonium propylmethacrylamide (SPP from Raschig), and sulfopropyl-2-vinylpyridinium (SPV from Raschig), 3-((3-methacrylamidopropyl)dimethylammonio)propane-1-sulfonate (SZ), phosphobetaine monomers, such as phosphatoethyl trimethylammonium ethyl methacrylate, carboxybetaine monomers, N-(carboxymethyl)-3-methacrylamido-N,N-dimethlpropan-1-aminium chloride (CZ). In one example, the zwitterionic monomeric unit is derived from CZ, SZ, and mixtures thereof.

In one example, a polymer of the present invention may comprise at least one monomeric unit selected from groups a (nonionic monomeric units) and b (anionic monomeric units) and at least one monomeric unit selected from groups c (cationic monomeric units) and d (zwitterionic monomeric units).

In one example, the film-forming polymer comprises at least 69.9% wt and/or at least 70% wt and/or at least 75% wt and/or at least 80% wt and/or at least 85% wt and/or at least 90% wt and/or at least 95% wt and/or at least 98% wt and/or at least 99% wt and/or at least 99.5% wt of a monomeric unit from group a. The balance of the film-forming polymer (no more than 30.1% wt and/or no more than 30% wt and/or no more than 25% wt and/or no more than 20% wt and/or no more than 15% wt and/or no more than 10% wt and/or no more than 5% wt and/or no more than 2% wt and/or no more than 1% wt and/or no more than 0.5% wt total) comprises one or more monomeric units selected from groups b, c, and d. In one example, the film-forming polymer comprises from about 70% to about 99.5% wt of a monomeric unit from group a, from about 0.1% to about 10% wt of a monomeric unit from group b, and from about 0.3% to about 29% wt of a monomeric unit from group c. In still another example, the film-forming polymer comprises from about 70% to about 99.5% wt of a monomeric unit from group a, from about 0.5% to about 30% wt combined of monomeric units from groups b and c.

In one example, the film-forming polymer comprises from about 70% to about 99.5% wt of a monomeric unit from group a, from about 0.1% to about 10% wt of a monomeric unit from group b, and from about 0% to about 29% wt of a monomeric unit from group d. In still another example, the film-forming polymer comprises from about 70% to about 99.5% wt of a monomeric unit from group a, from about 0.5% to about 30% wt combined of monomeric units from groups b and d.

In one example, the film-forming polymer comprises from about 70% to about 99.5% wt of a monomeric unit from group a, and the balance to 100% comprising from about 0.2% to about 29% wt of a monomeric unit from group c, and from about 0% to about 29% wt of a monomeric unit from group d. In still another example, the film-forming polymer comprises from about 70% to about 99.5% wt of a monomeric unit from group a, from about 0.5% to about 30% wt combined of monomeric units from groups c and d.

In one example, the film-forming polymer comprises at least 0.1% wt and/or at least 1% and/or at least 5% wt and/or at least 7% wt and/or at least 10% wt and/or to about 25% wt and/or to about 20% wt and/or to about 15% wt of a monomeric unit from group b.

In one example, film-forming polymer comprises at least 0.1% wt and/or at least 0.3% wt and/or at least 1% and/or at least 5% wt and/or at least 7% wt and/or at least 10% wt and/or to about 75% wt and/or to about 70% wt and/or to about 65% wt and/or to about 55% wt and/or to about 40% wt and/or to about 30% wt and/or to about 25% wt and/or to about 20% wt and/or to about 15% wt of a monomeric unit from group c.

In one example, film-forming polymer comprises at least 0.1% wt and/or at least 0.3% wt and/or at least 0.5% and/or at least 1% and/or at least 5% wt and/or at least 7% wt and/or at least 10% wt and/or to about 75% wt and/or to about 70% wt and/or to about 65% wt and/or to about 55% wt and/or to about 40% wt and/or to about 30% wt and/or to about 25% wt and/or to about 20% wt and/or to about 15% wt of a monomeric unit from group d.

In another example, the film-forming polymer comprises no more than 30.1% wt of a monomeric unit selected from the group consisting of: group b, group c, group d, and mixtures thereof.

In one example, the film-forming polymer may comprise a monomeric unit from group a and a monomeric unit from group b.

In one example, the film-forming polymer may comprise a monomeric unit from group a and a monomeric unit from group c.

In another example, the film-forming polymer of the present invention may comprise a monomeric unit from group a and a monomeric unit from group d.

In still another example, the film-forming polymer of the present invention may comprise a monomeric unit from group b and a monomeric unit from group c.

In still another example, the film-forming polymer of the present invention may comprise a monomeric unit from group b and a monomeric unit from group d.

In still another example, the film-forming polymer of the present invention may comprise a monomeric unit from group c and a monomeric unit from group d.

In yet another example, the film-forming polymer of the present invention may comprise a monomeric unit from group a, a monomeric unit from group b, and a monomeric unit from group c.

In even another example, the film-forming polymer of the present invention may comprise a monomeric unit from group a, a monomeric unit from group b, and a monomeric unit from group d.

In yet another example, the film-forming polymer of the present invention may comprise a monomeric unit from group a, a monomeric unit from group c, and a monomeric unit from group d.

In another example, the film-forming polymer of the present invention may comprise a monomeric unit from group b, a monomeric unit from group c, and a monomeric unit from group d.

In even yet another example, the film-forming polymer of the present invention may comprise a monomeric unit from group a, a monomeric unit from group b, a monomeric unit from group c and a monomeric unit from group d.

In one example, when present in the film-forming polymer, the monomeric unit from group b and the monomeric unit from group c are present in the polymer at a molar ratio of from about 3:1 to 1:3 and/or from about 2:1 to 1:2 and/or from about 1.3:1 to 1:1.3 and/or about 1:1 or less or about 1:1 or more.

In another example, when present in the film-forming polymer, the monomeric unit from group b and the monomeric unit from group d are present in the polymer at a molar ratio of from about 3:1 to 1:3 and/or from about 2:1 to 1:2 and/or from about 1.3:1 to 1:1.3 and/or about 1:1 or less or about 1:1 or more.

In another example, when present in the film-forming polymer, the monomeric unit from group c and the monomeric unit from group d are present in the polymer at a molar ratio of from about 3:1 to 1:3 and/or from about 2:1 to 1:2 and/or from about 1.3:1 to 1:1.3 and/or about 1:1 or less or about 1:1 or more.

In still another example, the film-forming polymer comprises a monomeric unit from group a and a monomeric unit from group c. For example, the film-forming polymer may comprise an acrylamide monomeric unit and a quaternary ammonium monomeric unit. The quaternary monomeric unit may be selected from the group consisting of: monoquaternary ammonium monomeric units, diquaternary ammonium monomeric units, and triquaternary ammonium monomeric units. In one example, the polymer may comprise at least 69.9% wt of the monomeric unit from group a and no more than 30.1% wt of the monomeric unit from group c.

In still another example, the film-forming polymer comprises a monomeric unit from group a and a monomeric unit from group b. For example, the film-forming polymer may comprise an acrylamide monomeric unit and an acrylic acid monomeric unit. In one example, the film-forming polymer may comprise at least 69.9% wt of the monomeric unit from group a and no more than 30.1% wt of the monomeric unit from group b.

In yet another example, the film-forming polymer comprises a monomeric unit from group b and a monomeric unit from group c. For example, the film-forming polymer may comprise an anionic monomeric unit derived from an anionic monomer selected from the group consisting of: acrylic acid, methacrylic acid, 2-acrylamido-2-methylpropane sulfonic acid, carboxyethyl acrylate, and mixtures thereof and a quaternary ammonium monomeric unit. The quaternary ammonium monomeric unit may be derived from a quaternary monomer selected from the group consisting of: monoquaternary ammonium monomeric units, diquaternary ammonium monomeric units, triquaternary ammonium monomeric units, and mixtures thereof. In one example, the film-forming polymer comprises an anionic monomeric unit derived from acrylic acid and a quaternary ammonium monomeric unit derived from MAPTAC. In one example, the film-forming polymer may comprise no more than 25% wt of the monomeric unit from group b and no more than 75% wt of the monomeric unit from group c.

In even yet another example, the film-forming polymer comprises a monomeric unit from group a and a monomeric unit from group b and a monomer unit from group c. For example, the polymer may comprise an acrylamide monomeric unit, and an anionic monomeric unit derived from an anionic monomer selected from the group consisting of: acrylic acid, methacrylic acid, 2-acrylamido-2-methylpropane sulfonic acid, carboxyethyl acrylate, and mixtures thereof and a quaternary ammonium monomeric unit. The quaternary ammonium monomeric unit may be derived from a quaternary monomer selected from the group consisting of: monoquaternary ammonium monomeric units, diquaternary ammonium monomeric units, triquaternary ammonium monomeric units, and mixtures thereof. In one example, the film-forming polymer comprises a nonionic monomeric unit derived from acrylamide, an anionic monomeric unit derived from acrylic acid, and a cationic monomeric unit derived from MAPTAC. In another example, the film-forming polymer comprises a nonionic monomeric unit derived from acrylamide, an anionic monomeric unit derived from acrylic acid, and a cationic monomeric unit derived from DADMAC. In still another example, the film-forming polymer comprises a nonionic monomeric unit derived from acrylamide, an anionic monomeric unit derived from acrylic acid, and a cationic monomeric unit derived from TQ. In another example, the film-forming polymer comprises a nonionic monomeric unit derived from acrylamide, an anionic monomeric unit derived from CEA, and a cationic monomeric unit derived from MAPTAC. In still another example, the film-forming polymer comprises a nonionic monomeric unit derived from acrylamide, an anionic monomeric unit derived from AMPS, and a cationic monomeric unit derived from MAPTAC. In one example, the film-forming polymer may comprise at least 69.9% wt of the monomeric unit from group a and no more than 30.1% wt combined of the monomeric units from groups b and c. In another example, the film-forming polymer may comprise from about 70% to about 99.5% wt of the monomeric unit from group a, from 0.1% to about 30% wt of the monomeric unit from group b, and from about 0.1% to about 30% wt of the monomeric unit from group c. In still another example, the film-forming polymer may comprise from about 70% to about 99.5% wt of the monomeric unit from group a and from about 0.5% to 30% wt combined of the monomeric units from groups b and c.

In even still yet another example, the film-forming polymer comprises a monomeric unit from group a and a monomeric unit from group c and a monomer unit from group d. For example, the polymer may comprise an acrylamide monomeric unit, a quaternary ammonium monomeric unit, and a zwitterionic monomeric unit selected from the group consisting of: CZ, SZ, and mixtures thereof. The quaternary ammonium monomeric unit may be derived from a quaternary monomer selected from the group consisting of: monoquaternary ammonium monomeric units, diquaternary ammonium monomeric units, triquaternary ammonium monomeric units, and mixtures thereof. In one example, the film-forming polymer comprises a nonionic monomeric unit derived from acrylamide, a cationic monomeric unit derived from MAPTAC, and a zwitterionic monomeric unit derived from CZ. In another example, the film-forming polymer comprises a nonionic monomeric unit derived from acrylamide, a cationic monomeric unit derived from MAPTAC, and a zwitterionic monomeric unit derived from SZ. In one example, the film-forming polymer may comprise at least 69.9% wt of the monomeric unit from group a and no more than 30.1% wt combined of the monomeric units from groups c and d. In another example, the film-forming polymer may comprise from about 70% to about 99.5% wt of the monomeric unit from group a, from 0.1% to about 30% wt of the monomeric unit from group c, and from about 0.1% to about 30% wt of the monomeric unit from group d. In still another example, the film-forming polymer may comprise from about 70% to about 99.5% wt of the monomeric unit from group a and from about 0.5% to 30% wt combined of the monomeric units from groups c and d.

In even yet another example, the film-forming polymer comprises a monomeric unit from group a and a monomeric unit from group b and a monomer unit from group d. For example, the film-forming polymer may comprise an acrylamide monomeric unit, and an anionic monomeric unit derived from an anionic monomer selected from the group consisting of: acrylic acid, methacrylic acid, 2-acrylamido-2-methylpropane sulfonic acid, carboxyethyl acrylate, and mixtures thereof and a zwitterionic monomeric unit selected from the group consisting of: CZ, SZ, and mixtures thereof. In one example, the polymer comprises a nonionic monomeric unit derived from acrylamide, an anionic monomeric unit derived from acrylic acid, and zwitterionic monomeric unit derived from CZ. In another example, the film-forming polymer comprises a nonionic monomeric unit derived from acrylamide, an anionic monomeric unit derived from acrylic acid, and a zwitterionic monomeric unit derived from SZ. In one example, the film-forming polymer may comprise at least 69.9% wt of the monomeric unit from group a and no more than 30.1% wt combined of the monomeric units from groups b and d. In another example, the film-forming polymer may comprise from about 70% to about 99.5% wt of the monomeric unit from group a, from 0.1% to about 30% wt of the monomeric unit from group b, and from about 0.1% to about 30% wt of the monomeric unit from group d. In still another example, the film-forming polymer may comprise from about 70% to about 99.5% wt of the monomeric unit from group a and from about 0.5% to 30% wt combined of the monomeric units from groups b and d.

In even yet another example, the film-forming polymer comprises a monomeric unit from group a and a monomeric unit from group d. For example, the film-forming polymer may comprise an acrylamide monomeric unit, and a zwitterionic monomeric unit selected from the group consisting of: CZ, SZ, and mixtures thereof. In one example, the film-forming polymer comprises a nonionic monomeric unit derived from acrylamide and zwitterionic monomeric unit derived from CZ. In another example, the film-forming polymer comprises a nonionic monomeric unit derived from acrylamide and a zwitterionic monomeric unit derived from SZ. In one example, the film-forming polymer may comprise at least 69.9% wt of the monomeric unit from group a and no more than 30.1% wt of the monomeric unit from group d. In another example, the film-forming polymer may comprise from about 70% to about 99.5% wt of the monomeric unit from group a, from 0.5% to about 30% wt of the monomeric unit from group d.

In one example, the film-forming polymer of the present invention comprises a nonionic hydrophilic monomeric unit. Non-limiting examples of suitable hydrophilic monomeric units are derived from nonionic hydrophilic monomers selected from the group consisting of: hydroxyalkyl esters of α,β-ethylenically unsaturated acids, α,β-ethylenically unsaturated amides, α,β-ethylenically unsaturated monoalkyl amides, α,β-ethylenically unsaturated dialkyl amides, α,β-ethylenically unsaturated monomers bearing a water-soluble polyoxyalkylene segment of the poly(ethylene oxide) type, α,β-ethylenically unsaturated monomers which are precursors of hydrophilic units or segments, vinylpyrrolidones, α,β-ethylenically unsaturated monomers of the ureido type, and mixtures thereof. In one example, the nonionic hydrophilic monomeric unit is derived from acrylamide.

In another example, the film-forming polymer of the present invention comprises a nonionic hydrophobic monomeric unit. Non-limiting examples of suitable nonionic hydrophobic monomeric units are derived from nonionic hydrophobic monomers selected from the group consisting of: vinylaromatic monomers, vinyl halides, vinylidene halides, C₁-C₁₂ alkylesters of α,β-monoethylenically unsaturated acids, vinyl esters of saturated carboxylic acids, allyl esters of saturated carboxylic acids, α,β-monoethylenically unsaturated nitriles containing from 3 to 12 carbon atoms, α-olefins, conjugated dienes, and mixtures thereof.

In one example, the film-forming polymer comprises an anionic monomeric unit. Non-limiting examples of suitable anionic monomeric units are derived from anionic monomers selected from the group consisting of: monomers having at least one carboxylic function, for instance α,β-ethylenically unsaturated carboxylic acids or the corresponding anhydrides, monomers that are precursors of carboxylate functions, monomers having at least one sulfate or sulfonate function, monomers having at least one phosphonate or phosphate function, esters of ethylenically unsaturated phosphates, and mixtures thereof. In one example, the anionic monomeric unit is derived from an anionic monomer selected from the group consisting of: acrylic acid, methacrylic acid, 2-acrylamido-2-methylpropane sulfonic acid, carboxyethyl acrylate, and mixtures thereof.

In one example, the film-forming polymer comprises a cationic monomeric unit. Non-limiting examples of suitable cationic monomeric units are derived from cationic monomers selected from the group consisting of: acryloyl- or acryloyloxyammonium monomers, 1-ethyl-2-vinylpyridinium or 1-ethyl-4-vinylpyridinium bromide, chloride or methyl sulfate, N,N-dialkyldiallylamine monomers, polyquaternary monomers, N,N-(dialkylamino-ω-alkyl)amides of α,β-monoethylenically unsaturated carboxylic acids, α,β-monoethylenically unsaturated amino esters, vinylpyridines, vinylamine, vinylimidazolines, monomers that are precursors of amine functions which give rise to primary amine functions by simple acid or base hydrolysis, and mixtures thereof. In one example, the cationic monomeric unit is derived from MAPTAC. In another example, the cationic monomeric unit is derived from DADMAC. In still another example, the cationic monomeric unit is derived from 2-hydroxy-N¹-(3-(2((3-methacrylamidopropyl)dimethylammino)-acetamido)propyl)-N¹, N¹, N³, N³, N³-pentamethylpropane-1,3-diaminium chloride.

### Process for Making Film-Forming Polymers

The film-forming polymers of the present invention may be made by any suitable process known in the art. For example, the film-forming polymer may be made by radical polymerization.

The film-forming polymers of the present invention can be made by a wide variety of techniques, including bulk, solution, emulsion, or suspension polymerization. Polymerization methods and techniques for polymerization are described generally in Encyclopedia of Polymer Science and Technology, Interscience Publishers (New York), Vol. 7, pp. 361-431 (1967), and Kirk-Othmer Encyclopedia of Chemical Technology, 3rd edition, Vol 18, pp. 740-744, John Wiley & Sons (New York), 1982, both incorporated by reference herein. See also Sorenson, W. P. and Campbell, T. W., Preparative Methods of Polymer Chemistry. 2nd edition, Interscience Publishers (New York), 1968, pp. 248-251, incorporated by reference herein, for general reaction techniques suitable for the present invention. In one example, the polymers are made by free radical copolymerization, using water soluble initiators. Suitable free radical initiators include, but are not limited to, thermal initiators, redox couples, and photochemical initiators. Redox and photochemical initiators may be used for polymerization processes initiated at temperatures below about 30° C. (86° F.). Such initiators are described generally in Kirk-Othmer Encyclopedia of Chemical Technology, 3rd edition, John Wiley & Sons (New York), Vol. 13, pp. 355-373 (1981), incorporated by reference herein. Typical water soluble initiators that can provide radicals at 30° C. or below include redox couples, such as potassium persulfate/silver nitrate, and ascorbic acid/hydrogen peroxide. In one example, the method utilizes thermal initiators in polymerization processes conducted above 40° C. (104° F.). Water soluble initiators that can provide radicals at 40° C. (104° F.) or higher can be used. These include, but are not limited to, hydrogen peroxide, ammonium persulfate, and 2,2′-azobis(2-amidinopropane) dihydrochloride. In one example, water soluble starting monomers are polymerized in an aqueous alcohol solvent at 60° C. (140° F.) using 2,2′-azobis(2-amidinopropane) dihydrochloride as the initiator. The solvent should typically contain at least about 10% by volume, of alcohol in order to prevent the polymerization reaction medium from gelling. Suitable alcohols for use in such reaction include low molecular weight alcohols such as, but not limited to, methanol, ethanol, isopropanol, and butanol.

Another technique is a solution polymerization as described in U.S. Pat. No. 3,317,370, Kekish, issued May 2, 1967 and U.S. Pat. No. 3,410,828, Kekish, issued Nov. 12, 1968, both incorporated herein by reference. According to such process, the acrolein, or other aldehydic monomer, is copolymerized with a non-nucleophilic, water soluble, nitrogen-heterocyclic polymerizable monomer and a redox initiator system. The copolymer is then made cationic by reacting the copolymer with a water soluble amine or amine quaternary. Amines, including amine quaternaries, that are useful include, but are not limited to, primary, secondary, and tertiary amines such as ethylene diamine, diethylene triamine, triethylene tetramine, tetraethylene pentamine, or partial or fully quaternized derivatives of any of the foregoing, hydrazides and quaternaries thereof such as betaine hydrazide chloride, N—N-dimethylglycine hydrazide, unsymmetrical dimethyl hydrazides, polymers, such as those formed by reaction of urea and polyalkylene polyamines, guanidines, biguanides, guanylureas, mono and polyhydroxy polyamines and quaternaries thereof, etc. When using this emulsion copolymerization technique, it will be necessary to control molecular weight to within the ranges provided herein.

In one example, a method for making a film-forming polymer according to the present invention comprises the steps of:

i. providing two or more monomeric units selected from the group consisting of:
a. nonionic monomeric units;
b. anionic monomeric units;
c. cationic monomeric units;
d. zwitterionic monomeric units; and
e. mixtures thereof; and

ii. polymerizing the two or more monomeric units such that a film-forming polymer according to the present invention is produced. In one example, the step of polymerizing comprises the step of mixing the two or more monomeric units or the monomers from which they are derived with water to form a monomer solution and polymerizing the monomers to form a polymer solution. The monomer solution and/or polymer solution may be deoxygenated. In addition, the monomer solution and/or polymer solution may be subjected (heated) to a temperature of at least 25° C., such as 60° C. The temperatures used to make the polymer may be any suitable temperature so long as a polymer according to the present invention is produced. The monomer solution and/or polymer solution may be subject to such temperature for a time sufficient to polymerize the monomeric units into a polymer, for example at least 10 minutes, and/or at least 18 hours depending on the reaction conditions. An initiator, such as a free-radical initiator, may be added to the monomer solution and/or polymer solution to polymerize the monomeric units (monomers) within the monomer solution to produce a polymer of the present invention. The levels of free radical initiator(s) used to make the polymer may be any suitable level so long as a polymer according to the present invention is produced. The levels of the various monomeric units (monomers) used to make the polymer may be any suitable level so long as a polymer according to the present invention is produced.

### Non-Limiting Synthesis Examples

### Sample Preparation

### Initiator Solution Preparation

10 ml of water is added to a flask along with 1 gram of 2,2′-azobis(2-methylpropionamidine) dihydrochloride (available from Wako Chemicals), herein called V-50. This solution is sparged with argon gas to remove oxygen.

### Monomer Preparation

### Synthesis of 2-Hydroxy-N¹-(3-(2-((3-Methacrylamidopropyl)Dimethylammonio)-Acetamido)Propyl)-N¹,N¹,N³,N³,N³-Pentamethylpropane-1,3-Diaminium Chloride (Herein Called TQ)

To a jacketed round bottom flask equipped with mechanical stirrer, gas inlet, condenser and thermometer is added 340.6 grams of dimethylamino propyl methacrylamide (DMAPMA, available from Sigma-Aldrich), 238.8 grams of methyl chloroacetate (available from Sigma-Aldrich), 0.5 g 4-methoxy phenol (available from Sigma-Aldrich), and 423 grams of methanol (available from Sigma-Aldrich). The round bottom flask is heated at 70° C. for 5 hours. This reaction is cooled to room temperature and then 0.5 grams of 4-methoxy phenol (available from Sigma-Aldrich) and 225 grams of dimethylaminoipropylamine (available from Sigma-Aldrich) is added evenly over a 2 hour period. After 2 hours the reaction is heated to 65° C. for 2 hours after which methanol is distilled out at 50° C. under vacuum. To this is added 690 grams of (3-chloro-2-hydroxypropyl)trimethylammonium chloride (available as a 60% aqueous solution from Sigma-Aldrich). The temperature is maintained at 65-70° C. for 2 hours. During these 2 hours methanol is stripped out and water is added to make a 55% solution in water based on weight. The reaction is continued in water at 65-70° C. for another hour to yield the TQ monomer.

### Synthesis of 3-((3-Methacrylamidopropyl)Dimethylammonio)Propane-1-Sulfonate (Herein Called SZ)

Into a round bottom flask is added 26.4 grams of anhydrous acetonitrile (available from Sigma-Aldrich) and 15.5 grams of propane sultone (available from Sigma-Aldrich), and this is stirred for 30 minutes. After the 30 minutes, a solution of 25.6 grams of DMAPMA in 56.5 grams of acetonitrile is added. The mixture is stirred and warmed to 35° C. A white precipitate quickly forms. Once the white precipitate takes up the bulk of the volume, the liquid is decanted. The solid is washed once with acetonitrile and again the liquid is removed by decanting. The solids are then washed in 2× volume diethyl ether. They are then filtered via funnel and washed with copious amounts (via filtration) of diethyl ether. The NMR structure is consistent with the structure of the target molecule SZ.

### Synthesis of N-(Carboxymethyl)-3-Methacrylamido-N,N-Dimethylpropan-1-Aminium Chloride (Herein Called CZ)

To a round bottom flask is added 16.5 grams of methyl bromoacetate (available from Sigma-Aldrich), 74 grams of tetrahydrofuran (THF, available from Sigma-Aldrich), and 16.5 grams of DMAPMA. The solution is stirred for 16 hours at 25° C., and then the stirring is discontinued. After settling, the top layer of THF is discarded. The lower layer is washed with 50 mL of hexanes (available from Sigma-Aldrich) twice and becomes a viscous material. The material is then dissolved in 15 mL of methanol (available from Sigma-Aldrich) and precipitated into 150 mL of diethyl ether (available from Sigma-Aldrich). The precipitate is washed several times with diethylether until it becomes a viscous semi-solid. It is then dried overnight under high vacuum at room temperature. A small portion is taken for NMR analysis. The remainder of the intermediate is placed in a glass desiccator containing calcium chloride until the next step.

3.3 grams of the intermediate from above is dissolved in 10 mL of deionized water and run through a column consisting of 50 mL of Dowex Marathon A hydroxide exchange resin (available from VWR Scientific) in a glass column of 2.5 cm diameter at 2.7 mL/min. The effluent is collected and 13 mL of 1N hydrochloric acid (available from Sigma-Aldrich) is added. The water is dried off under vacuum at room temperature. The sample is then dried overnight under high vacuum at room temperature. The material is removed from the vacuum and a small portion is taken for NMR analysis. 2.71 g of deionized water is added to the material to form the finished product CZ which is stored as a solution in water.

Table 1 below and the following description illustrates non-limiting examples of 1:1 blends of cleaning agents according to the present invention (Examples 1a, 1b, 1c, 2, 3a, 3b, 4, and 5) and two comparative examples of blends that form coacervates (Examples 6 and 7), which may not perform as well as the other blends.

TABLE 1

| | Concentration (% weight) | | | | | | |
|---|---|---|---|---|---|---|---|
| Ingredients | EX. 1a | EX. 2 | EX. 3a | EX. 4 | EX. 5 | EX. 6 | EX. 7 |
| PolyDADMAC | 3.5 | 3.5 | 3.5 | 3.5 | 3.5 | 7.5 | 3.5 |
| Acrylamide- | 3.5 | 3.5 | 3.5 | 3.5 | 3.5 | 7.5 | 3.5 |
| DADMAC- | | | | | | | |
| acrylic acid | | | | | | | |
| terpolymer | | | | | | | |
| Plurlafac LF | — | 2.625 | 0.875 | — | 0.75 | — | — |
| 400 | | | | | | | |
| (alkoxylated | | | | | | | |
| unbranched | | | | | | | |
| fatty alcohol | | | | | | | |
| surfactant) | | | | | | | |
| Empigen BB | | | | | 0.125 | | |
| surfactant | | | | | | | |
| (lauryldimethyl | | | | | | | |
| betaine) | | | | | | | |
| Crodamol OS | — | — | 1.75 | — | 1.75 | — | — |
| (octyl stearate) | | | | | | | |
| Tinopal CBS | 0.0014 | 0.0014 | 0.0014 | 0.0014 | 0.0014 | 0.0014 | 0.0014 |
| (fluorescent | | | | | | | |
| dye) | | | | | | | |
| Buffering agent | | | | as needed | | | |
| (NaOH or | | | | | | | |
| H₂SO₄) | | | | | | | |
| Water | balance | balance | balance | balance | balance | balance | balance |
| pH | 4 | 4 | 4 | 5.5 | 4 | 4 | 7 |

Examples 1a through 1c below describe a physical blending of a terpolymer with a homopolymer, 2 co-polymers, or 3 homopolymers to achieve a desired stability chemical composition comprising nonionic, cationic, and anionic components. A terpolymer containing all desired components can be blended with homopolymer, co-polymer, or another terpolymer to further adjust other desired parameters such as molecular weight, charge density, desired amounts each monomer, etc.

### Example 1a

Preparation of a 1:1 by weight 7% active physical blend of 3.5% polyDADMAC homopolymer and 3.5% acrylamide-DADMAC-acrylic acid terpolymer aqueous solution at pH 4. Desired amounts of PolyDADMAC powder (89% active) (commercially available as Flobeads DB45SH from SNF, France) and Tinopal CBS powder (100% active) were first dissolved in water into which a desired amount of a terpolymer of acrylamide-DADMAC-acrylic acid solution (12% active) (commercially available as Merquat™ 3330 PR from Lubrizol Advanced Materials, Inc., Cleveland, Ohio) was added by stirring to make up 1 liter final water solution containing 3.5% DB45SH and 3.5% Merquar 3330 PR polymer blend. The pH of final solution was adjusted to pH 4 using H₂SO₄ as needed.

### Example 1b

Preparation of a 3:1 by weight 5% active physical blend of copolymers of acrylamide-MAPTAC and acrylamide-acrylic acid. Desired amounts of 5% active acrylamide-MAPTAC (99% AAM-1% MAPTAC) copolymer and 5% active acrylamide-acrylic acid (99% AAM-1% MAPTAC) copolymer aqueous solutions were mixed by stirring to prepare a 5% active blend with a weight ratio of 3(99% AAM-1% MAPTAC):1(99% AAM-1% AA).

### Example 1c

Preparation of a 16:3:1 by weight physical blend of polyacrylamide, polyDADMAC and polyacrylic acid homopolymers. A desired amount of a polyacrylamide homopolymer (Flopam FA920 SH) was first dissolved in water into which was added a desired amount of polyacrylic acid (Aldrich). The pH was adjusted to pH<6 to maintain acrylic acid polymer in an acidic form in order to prevent any potential interaction with cationic polyDADMAC. A desired amount of polyDADMAC aqeuous (commercially available as Flobeads DB45SH from SNF, France) was then added into polyacrylamide-polyacrylic acid aqueous solution to prepare a physical blend with a polymer weight ratio of 16AAM:3DADMAC:AA.

### Example 2

Preparation of a 1:1 by weight physical blend of 3.5% polyDADMAC homopolymer and 3.5% acrylamide-DADMAC-acrylic acid terpolymer aqueous solution with 2.625% surfactant at pH 4. Desired amounts of polyDADMAC powder (89% active) (commercially available as Flobeads DB45SH from SNF, France) and Tinopal CBS powder (100% active) were first dissolved in water into which desired amounts of a terpolymer of acrylamide-DADMAC-acrylic acid solution (12% active) (commercially available as Merquat™ 3330 PR from Lubrizol Advanced Materials, Inc., Cleveland, Ohio) and Plurafac LF 400 solution (100% active) were added by stirring to make up 1 liter final water solution containing 3.5% DB45SH and 3.5% Merquat™ 3330 PR polymer blend with 2.625% Plurafac LF400 surfactant. The pH of final solution was adjusted to pH 4 using H₂SO₄ as needed.

### Example 3a

Preparation of a 1:1 by weight physical blend of 3.5% polyDADMAC homopolymer and 3.5% acrylamide-DADMAC-acrylic acid terpolymer with 0.875% surfactant and 1.75% octyl stearate oil-in-water emulsion at pH 4. A separate solution of 1:1 blend of polyDADMAC powder (89% active) (commercially available as Flobeads DB45SH from SNF, France) and a terpolymer of acrylamide-DADMAC-acrylic acid solution (12% active) (commercially available as Merquat™ 3330 PR from Lubrizol Advanced Materials, Inc., Cleveland, Ohio) was first prepared by dissolving a desired amount of DB45SH powder into water (⅔ of total needed to make up 1 liter final solution) into which was added Merquat™ 3330 PR by stirring. In a separate container a desired amount of Cromadol OS octyl stearate was emulsified with a desired amount of Plurafac LF 400 surfactant in water (⅓ of total needed to make up 1 liter final solution). Finally, emulsified oil water solution was added into polymer blend solution to make 1 liter final solution with 3.5% DB45SH, 3.5% Merquat™ 3330 PR, 1.75 Cromadol OS and 0.875% Plurlafac LF 400. The pH of final solution was adjusted to pH 4 using H₂SO₄ as needed.

### Example 3b

Preparation of a 1:1 by weight physical blend of 3.5% polyDADMAC homopolymer and 3.5% acrylamide-DADMAC-acrylic acid terpolymer with 0.875% surfactant and 1.75 octyl stearate oil-in-water emulsion with reduced emulsion droplet size at pH 4. Follow the procedure given in Example 3a. As a last step, apply a high shear to reduce droplet size to a desired size.

### Example 4

Preparation of a 1:1 by weight physical blend of polyDADMAC homopolymer and acrylamide-DADMAC-acrylic acid terpolymer hydrogel at pH 5.5. Desired amounts of PolyDADMAC powder (89% active) (commercially available as Flobeads DB45SH from SNF, France) and Tinopal CBS powder (100% active) were first dissolved in water into which a desired amount of a terpolymer of acrylamide-DADMAC-acrylic acid solution (12% active) (commercially available as Merquat™ 3330 PR from Lubrizol Advanced Materials, Inc., Cleveland, Ohio) was added by stirring to make up 1 liter final water solution containing 3.5% DB45SH and 3.5% Merquat™ 3330 PR polymer blend. The pH of final solution was adjusted to pH 5.5 using NaOH as needed.

### Example 5

Preparation of a 1:1 by weight physical blend of 3.5% polyDADMAC homopolymer and 3.5% acrylamide-DADMAC-acrylic acid terpolymer with 0.875% two types of surfactants and 1.75% octyl stearate oil-in-water emulsion at pH 4. polyDADMAC powder (89% active) (commercially available as Flobeads DB45SH from SNF, France) and a terpolymer of acrylamide-DADMAC-acrylic acid solution (12% active) (commercially available as Merquat™ 3330 PR from Lubrizol Advanced Materials, Inc., Cleveland, Ohio) was first prepared by dissolving a desired amount of DB45SH powder into water (⅔ of total needed to make up 1 liter final solution) into which was added Merquat™ 3330 PR by stirring. In a separate container a desired amount of Cromadol OS octyl stearate was emulsified with desired amounts of Plurafac LF 400 and Empigen BB lauryldimethyl betaine surfactants in water (⅓ of total needed to make up 1 liter final solution). Finally, emulsified oil water solution was added into polymer blend solution to make 1 liter final solution with 3.5% DB45SH, 3.5% Merquat™ 3330 PR, 1.75 Cromadol OS and 0.75% Plurafac LF 400 and 0.125% Empigen BB detergent. The pH of final solution was adjusted to pH 4 using H₂SO₄ as needed.

### Example 6

Preparation of a 1:1 by weight physical blend of polyDADMAC homopolymer and acrylamide-DADMAC-acrylic acid terpolymer solution above critical coarcevate concentration. Desired amounts of PolyDADMAC powder (89% active) (commercially available as Flobeads DB45SH from SNF, France) and Tinopal CBS powder (100% active) were first dissolved in water into which a desired amount of a terpolymer of acrylamide-DADMAC-acrylic acid solution (12% active) (commercially available as Merquat™ 3330 PR from Lubrizol Advanced Materials, Inc., Cleveland, Ohio) was added by stirring to make up 1 liter final water solution containing 7.5% DB45SH and 7.5% Merquat™ 3330 PR polymer blend. The pH of final solution was adjusted to pH 4 using H2504 as needed.

### Example 7

Preparation of water insoluble/dispersable coarcevate phase at pH 7 from a 1:1 by weight physical blend of polyDADMAC homopolymer and acrylamide-DADMAC-acrylic acid terpolymer solution. Desired amounts of PolyDADMAC powder (89% active) (commercially available as Flobeads DB45SH from SNF, France) and Tinopal CBS powder (100% active) were first dissolved in water into which a desired amount of a terpolymer of acrylamide-DADMAC-acrylic acid solution (12% active) (commercially available as Merquat™ 3330 PR from Lubrizol Advanced Materials, Inc., Cleveland, Ohio) was added by stirring to make up 1 liter final water solution containing 2% DB45SH and 2% Merquat™ 3330 PR polymer blend. The pH of final solution was adjusted to pH 7 using NaOH as needed. A water insoluble/dispersable phase was separated and used for cleaning efficacy testing.

### Cleaning Article

A non-limiting example of a cleaning article of the present invention comprising one or more cleaning agents of the present invention includes a dry cleaning article, for example a dry fibrous structure such as a dry paper towel, rather than a pre-moistened, liquid composition-containing towel or wipe or pad, that exhibits improved and/or superior average Mirror Cleaning Densitometer Values as measured according to the Mirror Cleaning Test Method described herein even after being subjected to the Accelerated Aging Procedure described herein compared to known cleaning articles void of the cleaning agents of the present invention.

In one example, the cleaning article of the present invention exhibits an average Mirror Cleaning Densitometer Value of greater than −0.55 and/or greater than −0.51 and/or greater than −0.48 and/or greater than −0.45 and/or greater than −0.40 and/or greater than −0.35 and/or greater than −0.30 and/or greater than −0.25 as measured according to the Mirror Cleaning Test Method described herein after the cleaning article has been subjected to the Accelerated Aging Procedure described herein and/or the cleaning article retains at least 50% and/or at least 55% and/or at least 60% and/or at least 65% and/or at least 70% and/or at least 75% to about 100% and/or to about 95% and/or to about 90% of the initial average Mirror Cleaning Densitometer Value as measured according to the Mirror Cleaning Test Method described herein after the cleaning article has been subjected to the Accelerated Aging Procedure described herein.

In addition to the mirror cleaning properties, the cleaning article of the present invention may exhibit a Soil Adsorption Value of greater than 90 and/or greater than 110 and/or greater than 120 and/or greater than 150 and/or greater than 175 and/or greater than 180 and/or greater than 200 mg soil/g cleaning article as measured according to the Soil Adsorption Test Method described herein.

In one example, the cleaning article comprises a web. In another example, the cleaning article comprises a particle.

When the cleaning article comprises a web, the web may comprise a fibrous structure. The fibrous structure may be a dry fibrous structure.

The fibrous structure of the present invention may comprise a plurality of pulp fibers and/or a plurality of filaments. Further, the fibrous structure of the present invention may comprise a single-ply or multi-ply sanitary tissue product, such as a paper towel.

In another example, the cleaning article of the present invention may comprise a web, for example a fibrous structure, in the form of a cleaning pad suitable for use with a cleaning device, such as a floor cleaning device, for example a Swiffer® cleaning pad or equivalent cleaning pads.

In still another example, the cleaning article of the present invention may comprise a foam structure.

The cleaning article of the present invention may comprise one or more cleaning agents according to the present invention. When present, the one or more cleaning agents may be present on a surface of the cleaning article at a level of greater than 0.005% and/or greater than 0.01% and/or greater than 0.05% and/or greater than 0.1% and/or greater than 0.15% and/or greater than 0.2% and/or less than 5% and/or less than 3% and/or less than 2% and/or less than 1% by weight of the cleaning article. In one example, the cleaning article is present on as surface of the cleaning article at a level of from about 0.005% to about 1% by weight of the cleaning article.

In another example of the present invention, a cleaning article of the present invention may comprise one or more cleaning agents at a level of greater than 0.1 pounds/ton (#/ton) and/or greater than 1 #/ton and/or greater than 2 #/ton and/or greater than 3 #/ton and/or less than 20 #/ton and/or less than 15 #/ton and/or less than 10 #/ton by weight of the cleaning article. The level of cleaning agents present on a surface of the cleaning article as used herein according to the present invention is in terms of active solids basis of the one or more cleaning agents.

The cleaning article of the present invention and/or the cleanings agents of the present invention may further comprise other ingredients in addition to the one or more cleaning agents, for example a surfactant and/or an oil, thus forming an oil-in water emulsion. When an oil, such as an ester, for example octyl stearate, is present in the oil-in-water emulsion, the oil may be present at a level of from about 0% to about 5% and/or from about 0% to about 3% and/or from about 0% to about 1.75% by weight of the oil-in-water emulsion. The oil may be present as a processing aid to reduce hygiene issues during the application of the cleaning agents to a cleaning article. The surfactant may be present in the cleaning article and/or in combination with the cleaning agents at a level of from about 0.01% to about 0.5% by weight of the cleaning article. Non-limiting examples of suitable surfactants include C₈₋₁₆ alkyl polyglucoside, cocoamido propyl sulfobetaine, and mixtures thereof. The surfactant may be a nonionic, non-sudsing surfactant, for example an alkoxylated unbranched fatty alcohol.

In another example, the one or more cleaning agents may be present on a surface of the cleaning article in a pattern, such as a non-random repeating pattern composing lines and or letters/words, and/or present on regions of different density, different basis weight, different elevation and/or different texture of the cleaning article.

In still another example of the present invention, the cleaning article may provide a residual cleaning effect as measured according to the Mirror Cleaning Test Method described herein on a surface, such as a mirror, after adsorbing at least a portion of the soil previously present on the surface. Without being bound by theory, it is believed that this residual cleaning effect, which at least partially inhibits at least some soils from collecting and/or remaining on the surface, results from at least a portion of the one or more cleaning agents depositing on the surface and remaining on the surface after cleaning with the cleaning article.

Table 2 below shows average Mirror Cleaning Densitometer (“Density”) Values and average Soil Adsorption Values for cleaning articles, in this case dry fibrous structures (e.g., paper towels) (Invention with their respective cleaning agents) in accordance with the present invention and of known cleaning articles, such as dry fibrous structures (e.g., paper towels) (Comparative with their respective cleaning agents), as measured according to the Mirror Cleaning Test Method and Soil Adsorption Test Method described herein, both initially and after the cleaning articles have been subjected to the Accelerated Aging Procedure described herein.

TABLE 2

| | | Avg Soil | | Avg Mirror |
|---|---|---|---|---|
| | Avg Initial | Adsorption | Avg Mirror | Cleaning |
| Cleaning Article | Soil | Value - After | Cleaning | Densitometer |
| Comprising Cleaning | Adsorption | Accelerated Aging | Densitometer | Value - After |
| Agent having identified | Value | Procedure | Value - Initial | Accelerated Aging |
| Composition | (mg/g) | (mg/g) | Mirror Cleaning | Procedure |
| Invention - Terpolymer of | 170 | 165 | −0.30 | −0.48 |
| acrylamide-MAPTAC- | | | | |
| acrylic acid | | | | |
| Invention - Terpolymer of | 181 | 168 | −0.35 | −0.51 |
| acrylamide-DADMAC- | | | | |
| acrylic acid | | | | |
| Invention - Terpolymer of | 186.1 | 182.4 | — | −0.29 |
| 99% dimethylacrylamide- | | | | |
| 0.75% MAPTAC- | | | | |
| 0.25% AA | | | | |
| Invention - Homopolymer | 182.5 | 160.1 | — | −0.44 |
| of N,N-dimethylacrylamide | | | | |
| Invention - 3:1 physical | 202.9 | 181.2 | — | −0.23 |
| blend 99% AAM- | | | | |
| 1% MAPTAC copolymer | | | | |
| and 99% AAM-1% AA | | | | |
| copolymer | | | | |
| Invention - 3:1 physical | 202.3 | 178.0 | — | −0.22 |
| blend of 99% NDMAAM- | | | | |
| 1% MAPTAC and | | | | |
| 99% NDMAAM-1% AA | | | | |
| Invention - Coarcevate | 152.9 | — | — | −1.36 |
| phase with no mirror | | | | |
| cleaning and reduced soil | | | | |
| retention | | | | |
| (EXAMPLE 7) | | | | |
| Comparative - | 146 | 156.7 | −0.33 | −1.00 |
| Homopolymer of | | | | |
| polyDADMAC, Mw | | | | |
| 600K | | | | |
| Comparative - | 225 | 105.5 | −0.16 | −1.22 |
| Homopolymer of | | | | |
| acrylamide (Mw 6 | | | | |
| million) | | | | |
| Comparative - Copolymer | 213.9 | 204.8 | NA | −1.16 |
| of 99% AAM:1% AA | | | | |
| Comparative - Copolymer | 221.9 | 128.7 | NA | −1.2 |
| of | | | | |
| 99% AAM:1% MAPTAC | | | | |
| Comparative - Copolymer | 193 | 184 | −0.29 | −0.94 |
| of acrylamide-DADMAC | | | | |
| Comparative - 1:1 blend | 197 | — | — | −0.5 |
| of homopolymer of | | | | |
| polyDADMAC (MW | | | | |
| 600K) and terpolymer of | | | | |
| acrylamide-DADMAC- | | | | |
| acrylic acid | | | | |
| (EXAMPLE 1a and 6) | | | | |

### Processes for Making Cleaning Articles

The base cleaning article (prior to cleaning agents being deposited thereo) of the present invention may be made by any suitable process known in the art. For example, if the cleaning article is a web, any suitable web making process can be used.

In one example, the cleaning article comprises a fibrous structure. The fibrous structure may be made by a process comprising the step of contacting a surface of the fibrous structure with one or more cleaning agents according to the present invention.

In another example of a process for making a cleaning article, such as a fibrous structure, comprises the steps of:
a. providing a fiber slurry;
b. depositing the fiber slurry onto a foraminous wire to form an embryonic web;
c. drying the embryonic web to produce a fibrous structure; and
d. contacting the fibrous structure with one or more cleaning agents of the present invention to produce a cleaning article (a fibrous structure, for example a dry fibrous structure, such as a paper towel) in accordance with the present invention.

The fiber slurry may comprise permanent and/or temporary wet strength agents such as Kymene® (permanent wet strength) and Hercobond® (temporary wet strength) both available from Ashland Inc.

In one example, the cleaning agents may be added to a fibrous structure of the present invention during papermaking, between the Yankee dryer and the reel, and/or during converting by applying it to one or more surfaces of the fibrous structure. In one example, a single-ply paper towel comprises one or more cleaning agents on one surface of the paper towel. In another example, a single-ply paper towel comprises one or more cleaning agents on both surfaces of the paper towel. In still another example, a two-ply paper towel comprises one or more cleaning agents on one or both exterior surfaces of the two-ply paper towel. In still another example, a two-ply paper towel comprises one or more cleaning agents on one or more interior surfaces of the two-ply paper towel.

In another example, the cleaning article of the present invention may be made by printing one or more cleaning agents onto a surface of a cleaning article, such as a fibrous structure, for example in a converting operation. The printing operation may occur by any suitable printing equipment, for example by way of a gravure roll.

In another example, the cleaning article of the present invention may be made by applying one or more cleaning agents utilizing a rotating roll having a central longitudinal axis, wherein the rotating roll rotates about the central longitudinal axis. The rotating roll can have an exterior surface defining an interior region and a vascular network configured for transporting the cleaning agent in predetermined paths from an interior region to the exterior surface of the rotating roll. The vascular network can have a main artery, a first capillary and a plurality of fluid exits on the exterior surface. The main artery can have an inlet and is substantially parallel to the central longitudinal axis of the rotating roll. One or more cleaning agents enter the vascular network at the inlet and exit through substantially radial fluid paths to form a first tree. Once the cleaning agent is at the surface of the rotating roll, it is deposited onto a cleaning article, for example a fibrous structure. Additional examples of such a rotating roll are found in U.S. Published Application No. 2015-0343480 A1.

In still another example, a cleaning article of the present invention may be made by extruding, such as by slot extruding one or more cleaning agents onto a surface of a cleaning article, such as a fibrous structure.

In even another example, a cleaning article of the present invention may be made by spraying, such as with one or more nozzles, such as ITW Dynatec UFD nozzles commercially available from ITW Dynatec, Hendersonville, TN, one or more cleaning agents onto a surface of a cleaning article, such as a fibrous structure.

In yet another example, a cleaning article of the present invention may be made by spraying one or more cleaning agents onto a wet fibrous structure during papermaking after the vacuum dewatering step, but before the predryers and/or after the predryers, but before the Yankee.

The one or more cleaning agents may be applied to a surface of a cleaning article in a pattern, such as a non-random, repeating pattern.

### Non-Limiting Example

Articles of manufacture, in particular fibrous structures; namely, paper towels are produced utilizing a cellulose furnish consisting of a Northern Softwood Kraft (NSK) and Eucalyptus Hardwood (EUC) at a ratio of approximately 70/30. The NSK is refined as needed to maintain target wet burst at the reel. Any furnish preparation and refining methodology common to the papermaking industry can be utilized.

A 3% active solution Kymene 1142 is added to the refined NSK line prior to an in-line static mixer and 1% active solution of Advantage DF285, an ethoxylated fatty alcohol defoamer available from Ashland Inc. is added to the EUC furnish. The addition levels are 21 and 1 lbs active/ton of paper, respectively.

The NSK and EUC thick stocks are then blended into a single thick stock line followed by addition of 1% active carboxymethylcellulose (CMC) solution at 7 and 1 lbs active/ton of paper towel, and optionally, a softening agent may be added.

A Mirapol® HSC-300 stock solution available from Rhodia is prepared by dilution of the 20% active neat solution to 2% and neutralized to pH 4.5-5.0 with NaOH. The 2% active Mirapol® HSC-300 solution is blended into the thick stock after the CMC addition to achieve between 5 and 10 lbs active Mirapol® HSC-300/ton of paper towel. Immediately following the addition, the thick stock travels through an in-line Lightnin mixer.

The thick stock is then diluted with white water at the inlet of a fan pump to a consistency of about 0.15% based on total weight of NSK and EUC fiber. The diluted fiber slurry is directed to a non layered configuration headbox such that the wet web formed onto a Fourdrinier wire (foraminous wire).

Dewatering occurs through the Fourdrinier wire and is assisted by deflector and vacuum boxes. The Fourdrinier wire is of a 5-shed, satin weave configuration having 87 machine-direction and 76 cross-direction monofilaments per inch, respectively. The speed of the Fourdrinier wire is about 750 fpm (feet per minute).

The embryonic wet web is transferred from the Fourdrinier wire at a fiber consistency of about 24% at the point of transfer, to a patterned belt through-air-drying resin carrying fabric. To provide fibrous structure products of the present invention, the speed of the patterned through-air-drying fabric is approximately the same as the speed of the Fourdrinier wire. In another example, the embryonic wet web may be transferred to a patterned belt and/or fabric that is traveling slower, for example about 20% slower than the speed of the Fourdrinier wire (for example a wet molding process.

Further de-watering is accomplished by vacuum assisted drainage until the web has a fiber consistency of about 30%.

While remaining in contact with the patterned drying fabric, the web is pre-dried by air blow-through pre-dryers to a fiber consistency of about 65% by weight.

After the pre-dryers, the semi-dry web is transferred to a Yankee dryer and adhered to the surface of the Yankee dryer with a sprayed creping adhesive. The creping adhesive is an aqueous dispersion with the actives consisting of about 22% polyvinyl alcohol, about 11% CREPETROL® A3025, and about 67% CREPETROL® R6390. CREPETROL® A3025 and CREPETROL® R6390 are commercially available from Ashland Inc. (formerly Hercules Inc.). The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25° and is positioned with respect to the Yankee dryer to provide an impact angle of about 81°. The Yankee dryer is operated at a temperature of about 177° C. and a speed of about 800 fpm. The fibrous structure is wound in a roll using a surface driven reel drum having a surface speed of about 656 feet per minute. In another example, the doctor blade may have a bevel angle of about 45° and is positioned with respect to the Yankee dryer to provide an impact angle of about 101° and the reel may be run at a speed that is about 15% faster than the speed of the Yankee.

The fibrous structure may be subsequently converted into a two-ply paper towel product having a basis weight of about 28-33 lbs/3000 ft².

### Non-Limiting Examples of Cleaning Articles of the Present Invention

The following non-limiting examples illustrate the inclusion of one or more cleaning agents onto a paper towel to provide a paper towel in accordance with the present invention. The mirror cleaning properties and soil adsorption properties for each of the examples below are shown in Table 2 above.

### Example 8—Paper Towel Comprising a Cleaning Agent

1.8#/ton of Merquat™ 2003 PR (terpolymer of acrylamide-MAPTAC-acrylic acid) available from Lubrizol Advanced Materials, Inc., Cleveland, Ohio, is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the Merquat™ 2003 PR is out.

### Example 9—Paper Towel Comprising a Cleaning Agent

1.8#/ton of Merquat™ 3330 PR (terpolymer of acrylamide-DADMAC-acrylic acid) available from Lubrizol Advanced Materials, Inc., Cleveland, Ohio, is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the Merquat™ 3330 PR is out.

### Example 10—Paper Towel Comprising a Cleaning Agent

1.8#/ton of terpolymer of 99% N,N-dimethylacrylamide-0.75% MAPTAC-0.25% acrylic acid is made up and is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the terpolymer is out.

### Example 11—Paper Towel Comprising a Cleaning Agent

1.8#/ton of poly N,N-dimethylacrylamide is made up and is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the poly N,N-dimethylacrylamide is out.

### Example 12—Paper Towel Comprising a Polyquaternary Ammonium Compound

1.8#/ton of a 3:1 physical blend 99% AAM-1% MAPTAC copolymer and 99% AAM-1% AA copolymer is made up and is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the blend is out.

### Example 13—Paper Towel Comprising a Polyquaternary Ammonium Compound

1.8#/ton of a 3:1 physical blend of 99% NDMAAM-1% MAPTAC and 99% NDMAAM-1% AA is made up and is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the blend is out.

### Comparative Example 14—Paper Towel Comprising a PolyDADMAC

1.8#/ton of polyDADMAC powder (89% active) (Weight Average Molecular Weight of 600,000 g/mol) (commercially available as Flobeads DB45SH from SNF, France), which has been dissolved in water, is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the polyDADMAC is out.

### Comparative Example 15—Paper Towel Comprising a Polyacrylamide

1.8#/ton of polyacrylamide (Weight Average Molecular Weight of 6,000,000 g/mol) is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the polyacrylamide is out.

### Comparative Example 16—Paper Towel Comprising a Copolymer of 99% AAM:1% AA

1.8#/ton of a Copolymer of 99% AAM:1% AA is made up and is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the copolymer is out.

### Comparative Example 17—Paper Towel Comprising a Copolymer of 99% AAM:1% MAPTAC

1.8#/ton of a Copolymer of 99% AAM:1% MAPTAC, is made up and is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the polyDADMAC is out.

### Comparative Example 18—Paper Towel Comprising a Copolymer of Acrylamide-DADMAC

1.8#/ton of a Merquat™ 2200 available from Lubrizol Advanced Materials, Inc., Cleveland, Ohio, is applied directly to a surface of a fibrous structure via a spray application in papermaking onto the fabric side and/or the wire side of the dry fibrous structure between the calender and the reel. The paper is then converted into a 2-ply finished product roll with the fabric side out or wire side out and/or one fabric side and one wire side out such that at least one side containing the Merquat™ 2200 is out.

### Test Methods

Unless otherwise specified, all tests described herein including those described under the Definitions section and the following test methods are conducted on samples that have been conditioned in a conditioned room (CTCH room) at a temperature of 23° C.±1.0° C. and a relative humidity of 50%±2% for a minimum of 2 hours prior to the test. All plastic and paper board packaging articles of manufacture must be carefully removed from the paper samples prior to testing. The samples tested are “usable units.” “Usable units” as used herein means sheets, flats from roll stock, pre-converted flats, and/or single or multi-ply products. Except where noted all tests are conducted in such conditioned room, all tests are conducted under the same environmental conditions and in such conditioned room. Any damaged product is discarded. Test samples with defects such as wrinkles, tears, holes, and like are not measured. Samples conditioned as described herein are considered dry samples (such as “dry filaments”) for testing purposes. All instruments are calibrated according to manufacturer's specifications.

### Accelerated Aging Procedure

Finished Product stability is defined as the ability of the Finished Product to deliver its intended performance after subjection to the normal range of storage, delivery, and retail conditions. Finished product rolls were packaged using 0.6 mil low density polyethylene film (a proprietary film, Extrel EX1560 available from Tredegar Corporation for this limited purpose) following the procedure detailed below:
1. Cut a 2×3 ft section of 0.6 mil low density polyethylene film.
2. Lay two finished product rolls of paper towels on poly film about 4 inches from the edge of the film such that the rolls are aligned with the 3 ft dimension, and fold poly along the length of the poly over top of the length of the rolls.
3. Heat seal the fold using 3 parallel seals ⅓ inch between each parallel line to insure an effective seal along the length of the rolls.
4. Heat seal on one end about an inch from the end of the poly. This forms a “sock” around the two rolls.
5. Taking care to minimize the volume of air that remains within the finished package, heat seal the final end an inch from the final edge of the 3 ft length of poly forming an airtight seal around the rolls.

The relatively long tail on the package permits samples to be taken off the rolls for testing, resealed and returned to the CTCH room for additional aging. Accelerated and Stress aging conditions are as follows:

Accelerated Aging (40° C.+/−2°, 75% RH+/−5% for 1 month);

Samples are taken for testing by removing the package from the CTCH room, cutting the end of the package near as possible to the heat seal, remove the rolls, remove 2 sheets from the outside of the rolls and discard, remove 4 full size sheets for mirror cleaning testing and 1 additional sheet for soil adsorption testing.

### Mirror Cleaning Test Method

A test stand cart holding 4 individual 28″×28″ mirrors (one on each of the 4 sides) resting on a flat surface, such as a floor, is utilized for the mirror cleaning test. The silver mirror layer is on the back surface of a flat clear glass sheet approximately 5 mm thick. The cart is configured such that the bottom edge of each mirror is approximately 3′ 6″ off the flat surface. A handheld light is utilized to aid in visualization of streaks. Best results are achieved by moving the hand held light along the surface of the mirror while viewing from the side as opposed to looking perpendicular to the surface of the mirror.

The mirror is prepared for testing by cleaning as follows: 1) Windex® commercially available from SC Johnson (a composition containing 0.1-1.0% by weight of Ethyleneglycol Monohexylether, 1.0-5.0% by weight of Isopropanol, and 90-100% by weight of Water) or equivalent is sprayed (4 full sprays, about 3.5 g of solution) onto the mirror surface which is then spread across the entire surface of the mirror with 2 sheets of a 1-ply paper towel, for example 2010 commercially available Bounty® Basic (folded into quarters) using a circular wiping motion; 2) the mirror surface is then wiped dry and lightly polished with the essentially dry side of the folded 1-ply paper towel; 3) wiping the mirror surface with an additional two sheets of the 1-ply paper towel saturated with deionized water; and 4) using a squeegee in a top to bottom motion to remove all excess deionized water. Steps 3) & 4) may be repeated as necessary to achieve a streak and smudge free mirror surface that has no residual impact on the cleaning performance of subsequent test articles of manufacture. Any suitable absorbent substrate can be used in place of Bounty Basic that is not impregnated with polymers that may be deposited onto the glass surface, which may impact the ease or difficulty of cleaning with subsequent test cleaning article.

A model soil suspension is prepared by suspending 1% by weight of Black Todd Clay in a 50/50 weight ratio of water/isopropyl alcohol mixture containing 0.05% by weight of 100% soybean oil (viscosity of from 150 cP to 200 cP).

Preparation of 100% cooked soybean oil is as follows. Approximately 200 grams of 100% soybean oil available from Spectrum Chemical Manufacturing Corp., 14422 S. San Pedro St., Gardena, Calif. 90248 is placed in a 1000 mL beaker with stir bar. The soybean oil in the beaker is placed on a hot plate and heated to 204° C. while stirring slowly. Air is added through a glass pipette tip set to bubble continuously through the oil. The oil is cooked continuously until viscosity, at 25° C.±2.2° C., is between 150 and 200 cP. The color changes to a dark orange. Viscosity is measured using a Cannon-Ubbelohde Viscometer tube #350 available from Cannon Instrument Company, State College, Pa. 16803, or equivalent viscometer. A sample of oil which is near room temperature is added to the viscometer and equilibrated to 25° C. in a constant temperature water bath. The efflux time for the meniscus to pass from the top mark to the bottom mark is measured to within ±0.01 second while allowing the oil to flow through the viscometer tube under gravity. Kinematic viscosity in mm²/s is calculated by multiplying the time in seconds by the calibration constant supplied with the viscometer tube. Separately the fluid density is determined by measuring the weight of a fixed volume of oil using a 25 mL volumetric flask and a 4 place analytical balance. Viscosity in cP can be calculated by multiplying the Kinematic viscosity by density of oil in g/mL. The cooking time will vary depending on quantity, surface area and air flow through the oil.

The following procedure is used to apply model soil to the clean mirror surfaces. The target amount of model soil sprayed is 44 g+/−2.5 g. A spray bottle, part #0245-01 available from www.SKS-bottle.com or equivalent spray bottle is used to spray the model soil suspension onto the mirror surface. Fill the spray bottle with the model soil suspension and weigh to the nearest 0.01 g and record as initial weight. The spray bottle is then manually pressurized as needed to achieve a dispersed spray of fine droplets. Additional pressurization is required between each mirror. Holding the spray bottle about 1.5 feet from the mirror surface a substantially horizontal sweeping motion is used starting at the top of the mirror surface and working down to the bottom of the mirror surface traversing the mirror surface a total of 8 times while attempting to have relatively even coverage on the mirror surface. After applying the model soil suspension to all 4 mirrors, the spray bottle and remaining contents are weighed to the nearest 0.01 g and recorded as weight after first spray. The mirrors are dried sequentially using a handheld hair dryer. The difference between the initial weight and after first spray is used to adjust the amount of spray applied in a second application to achieve the target amount of 44 g+/−2.5 g. The second application of the model soil suspension is applied to each mirror surface in a circular motion, moving from the outside (approximately 8-10 inches from the side edges) inward toward the center. After drying the second application of model soil suspension the mirrors are ready to be cleaned with a cleaning article (“specimen”) to be tested. If the time between soil application and cleaning of the mirrors with a test sample extends past 30 minutes, the mirrors need to be returned to their pristine condition using the procedure define previously after which the soil application procedure can be repeated.

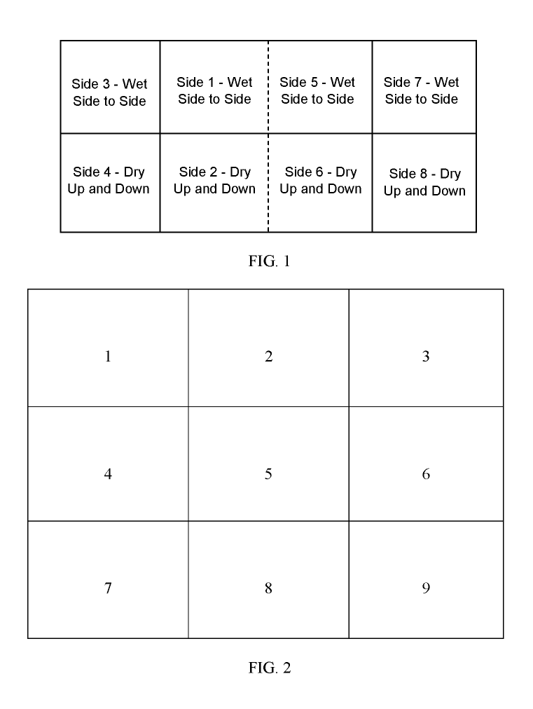

A specimen of a test cleaning article, for example a paper towel, is prepared as follows. Two sheets of the cleaning article, for example a paper towel, may be delineated and connected to adjacent sheets by perforation or tear lines or the sheets of the sample may be individual sheets, such as in the form of individual wipes, napkins, and/or facial tissues. If the cleaning article, for example a paper towel, is a select-a-size format, then 4 sheets are used. Individual sheet dimensions or in the case of select-a-size two sheets vary by brand from about 8.5″×11″ to 14″×11″ and 2.20 g to 5.2 g. The 2 or for select-a-size 4 sheet specimen is folded in half as shown in FIG. 1 (along perforations if present) with the emboss side out (where applicable). As shown in FIG. 1, the folded sample is then folded in half again with the crease perpendicular to the MD direction and then folded in half again perpendicular to the CD direction such that a sample pad of quarter size sheet that is 8 sheets thick is formed, each sheet may consist of 1, 2 or more individual plies. The mirror surface is then treated with 5 full sprays of Windex: two at top; one in the center and two in the lower area of the mirror. The weight of Windex sprayed per mirror is about 4.35 g±0.36 g. The mirror surface is cleaned by grasping the sample pad in the hand, clamping the substrate between the thumb and index finger and wiping with firm pressure in a cross direction, while holding the sheet (side 1) as flat as possible upon the surface of the mirror and avoiding contacting the mirror with any part of the hand using 8 side-to-side passes, such that the full surface of the mirror is contacted. The sample pad is then turned over and the relatively dry back-side (side 2) is used to wipe the mirror surface in an up and down motion, with firm pressure applied using 14 passes, ensuring that the entire surface of the mirror is contacted, again holding the sample pad as flat against the mirror surface as possible. The sample pad is then unfolded once and then folded back on itself revealing a relatively fresh sample pad surfaces to clean the second mirror after application of Windex as discussed above; side 3 (opposite side 1) is used for the side-to-side wiping and then turned over to side 4 (opposite side 2) for the up and down wiping. The pad is then unfolded twice to reveal a fresh surface of the specimen. The specimen is then folded in half such that the fresh sample surface is visible with the two used areas of the first sample pad configuration (sides 1 and 3) facing each other and then folded again to clean the third mirror surface after application of Windex as discussed above. Side 5 opposite side 1 and 3 is used first and then turned over to side 6 for the second up and down wiping. The sample pad is unfolded once and then folded back on itself revealing sides 7 and 8 to clean the fourth mirror surface after application of Windex as discussed above. Side 7 opposite sides 5, 3 & 1 is used for the side-to-side wiping and then turned over to side 8 for the final up and down wiping. In each case the wettest part of the folded sample pad is used for the side-to-side wiping and the dryer side for the final up and down wiping; see FIG. 2 for an overview of the uses of the various portions of the sample of cleaning article.

All 4 mirror surfaces should be cleaned sequentially such that minimal drying of the specimen pad occurs. After cleaning all four mirror surfaces, the mirror surface is permitted to dry and each mirror surface is visually graded for streaks on a 0 to 4 scale with aid of a handheld light. The qualitative grading scale is described below:
“0” represents streak/smudge free mirror surface;
“1” represents mirror surface with a few very light streaks.
“2” represents mirror surface with light or moderately visible streaks on nearly every up and down wipe.
“3” representing mirror surface that has moderate to heavy streaks where the streaks are starting to run together.
“4” represents mirror surface that has heavy streaks on every up and down pass and has a relatively continuous hazy appearance.
   Half units e.g. 1.5 etc can be used as deemed necessary to most accurately describe the visual appearance of the mirrors enabling one to differentiate between heavy or light streaks and hazy appearance. The 4 individual grades are reported separately; averaged to report an average Mirror Cleaning Visual Grade Value; and summed to report a total Mirror Cleaning Visual Grade Value for the cleaning article.

In addition to the visual grading scale, a measurement of optical density utilizing an X-Rite 518 Spectrodensitometer to differentiate cleaning performance of sample specimens is used. A full calibration as described in the operators manual is performed. The instrument is set-up per instructions in the manual in Density minus Reference Measurement Mode. The four 28″×28″ mirror surfaces were cleaned as described above representing a pristine condition. A single reading of a mirror in pristine condition is completed and stored as Refl and is used as a reference for all subsequent measurements. A series of 9 measurements are made on each of the 4 mirrors (3 across the top, 3 across the middle and 3 across the bottom always maintaining a minimum of 3 inches from any edge of the mirror) as shown in FIG. 2. The mirror cleaning test stand is oriented in the lab such that there is no direct overhead lighting and rotated such that the mirror being measured is facing towards an interior wall thus minimizing any influence caused by external lighting differences. Measurements were performed on the each of the pristine mirrors. These 9 individual values are averaged for each mirror. The average values were found to be consistent between mirrors, however, as expected the average shows a small difference from the single point reference. This difference is used to correct all subsequent average values measured. Additionally, average values were determined for mirrors after application of the model soils. The corrected average density readings for the 4 soiled mirrors ranged from −1.84 to −1.90. After, following the cleaning procedure with the sample specimen, 9 density readings are performed and an average Mirror Cleaning Densitometer Value is reported for each of the individual mirrors and across all 4 mirrors. The orientation of the mirrors and room lighting is such that streaks are not readily visible thus insuring a random location of each measurement taken within the limitations of the 3×3 grid described above. Furthermore, the density measurements correlate well with the visual grading system.

The above described Mirror Cleaning Test Method includes a cleaning process that insures there is no residual cleaning effect resulting from residual polyquaternary ammonium compound that remains on a mirror surface (hard surface) after cleaning with a cleaning article of the present invention, which comprises a polyquaternary ammonium compound, according to the test. To measure any residual cleaning effect from a cleaning article comprising a polyquaternary ammonium compound, the above-described Mirror Cleaning Test Method is modified, where the normal process of bringing the mirrors back to their pristine condition is eliminated and replaced with a second cleaning step utilizing the Windex and a cleaning article comprising a cleaning agent. As a means of accelerating the potential buildup of cleaning agents on the mirror, a cleaning article is prepared with an exaggerated level of a cleaning agents (12#/ton) applied to the external surfaces of a cleaning article, such as a 2-ply fibrous structure for example a 2-ply paper towel. Initially, the mirrors are prepared utilizing the normal process described above of returning the mirrors to their pristine condition followed by application of the soil suspension. Each of the 4 mirrors are then cleaned with a control cleaning article, such as a fibrous structure for example a paper towel (containing no cleaning agents) and graded utilizing the visual grading technique and the densitometer. The mirrors are then cleaned twice as described above but with the cleaning article comprising the 12#/ton cleaning agent and the Windex. Visual inspection of the mirrors with aid of handheld light showed no streaks or smudges e.g. the mirrors are visually in pristine condition. Another round of soil suspension is then applied to the mirrors utilizing the normal technique and cleaned with the control product and visually graded. The mirrors were then returned to their pristine condition utilizing the normal cleaning procedure twice to insure complete removal of any residual soil attracting polymer. Another round of soil suspension is then applied and the mirrors are cleaned with the control and visually graded utilizing the handheld light.

### Polymer Molecular Weight Determination

Polymer molecular mass is determined by GPC SEC/MALS. The HPLC is a Waters Alliance 2695 HPLC with an auto injector equipped with a bank of two linear μStyragel HT columns at room temperature. The flow rate is 1.0 mL/min and the mobile phase is dimethyl sulfoxide (DMSO) with 0.1% (weight/volume) LiBr. The detectors are Wyatt Dawn EOS Light scattering detector calibrated with toluene and normalized using 25K dextran in mobile phase and a Wyatt Optilab rEX refractive index detector at 30° C.

Samples for analysis are prepared at a known concentration in the range of 1 to 5 mg/mL. Samples are filtered using 0.2 μm polypropylene membrane filters. The injection volume is 100 μL. The data are collected and analyzed using ASTRA 5.3.4.14. Values for do/dc are calculated from the RI trace assuming 100% mass recovery. Number average molecular weight and polydispersity index are calculated and reported.

### Soil Adsorption Test Method

In order to measure a cleaning article's Average Soil Adsorption Value the following test is conducted.

Preparation:

A specimen of the cleaning article, such as a fibrous structure, to be tested is obtained from the central portion of a representative sample of the cleaning article. The specimen is prepared by cutting a CD strip (extending across the entire CD of the cleaning article) from a cleaning article, such as a finished fibrous structure and/or sanitary tissue product sheet (sample) such that the cut CD strip specimen has a length and width resulting in the specimen weighing 0.65 g±0.02 g. The sheet of the sample from which the CD strip specimen is cut may be delineated and connected to adjacent sheets by perforation or tear lines or the sheets of the sample may be individual sheets, such as in the form of individual wipes and/or facial tissues. If connected via perforation or tear lines, then separate one sheet from any adjacent sheet before cutting the CD strip from the sheet. The CD strip specimen needs to be free of perforations and is obtained from a portion of a cleaning article at least 0.5 inches from any perforations. The specimen is conditioned as described above. The sample weight (w) Prod, is recorded to the within ±0.0001 g. A suitable ball-point pen or equivalent marker is used to write the specimen name onto a corner of the specimen.

A centrifuge tube (VWR brand 50 mL superclear ultra high performance freestanding centrifuge tube with flat caps, VWR Catalog #82018-052; or equivalent tube) is labeled with the specimen name and weighed to within ±0.1 mg W_{CT}. Next, 155.0 mg±5.0 mg of a model soil (black todd clay) available from Empirical Manufacturing Co., 7616 Reinhold Drive, Cincinnati, Ohio 45237-3208) is placed into the centrifuge tube. The tube is re-weighed W_{(CT+Soil)} and the model soil weight (Wₛₒᵢₗ) is determined to nearest 0.2 mg by difference W_{(CT+Soil)}−W_{CT}.

Distilled water, 35 g±0.5 g is added slowly to the centrifuge tube using a suitable dispenser. The centrifuge tube is a VWR brand 50 mL superclear ultra high performance freestanding centrifuge tube with flat caps (VWR Catalog #82018-052, or equivalent tube). The distilled water is poured carefully into the centrifuge tube to avoid causing a plume of dust from the model soil. If a plume of dust occurs such that the weight of soil in the tube may be impacted, the tube is discarded and a new tube is prepared. The tube is then re-weighed W_{(CT+Soil+Water)} and the total weight (W_{(Soil Dispersion)} of water plus soil in the centrifuge tube is calculated by subtracting the weight of the centrifuge tube W_{CT} from the W_{(CT+Soil+Water)} and recorded to the nearest 0.2 mg.

A glass petri dish (e.g. VWR 50×35, VWR Catalog #89000-280, or equivalent dish) is labeled and weighed to within 0.1 mg (W_{(Petri Dish)}).

Testing:

A reciprocating shaker is used to disperse the model soil in the water. The model soil must be completely dispersed for the results to be valid. A reciprocating shaker (IKA Works HS 501 digital reciprocating shaker, number 2527001, with a Universal attachment, number 8000200, or equivalent shaker) is set to 300±3 cycles per minute. The capped centrifuge tube containing the model soil and water is mounted in the shaker and shaken for 30 seconds to obtain a uniform dispersion of the soil in the water (soil dispersion).

The specimen is loosely folded along its transverse centerline with an accordion style (paper fan) folding technique. The specimen is loosely folded 5 times, to produce a sample that contains 10 segments each about 2.5 cm in length. This folding technique keeps the sample from being too tightly folded, which may hinder free flow of water and suspended soil over all surfaces of the article the thus efficiency of the paper to adsorb the soil. The folded sample is fully immersed into the soil dispersion in the centrifuge tube so that the folds run parallel to the length of the centrifuge tube. The tube is immediately re-capped and shaken in the reciprocating shaker for 30+/−1 seconds with the length axis of the centrifuge tube parallel to the motion of the reciprocating shaker.

After shaking, the folded specimen is carefully removed over the glass petri dish using laboratory tweezers. Care must be taken to ensure that greater than 95% of the soil dispersion is kept either in the original centrifuge tube or corresponding glass petri dish. The soil dispersion is wrung (removed) from the specimen using a “wringing” motion and collected in the glass petri dish. Once the soil dispersion has been removed from the specimen, the specimen is discarded. The remaining soil dispersion is poured from the centrifuge tube into the glass petri dish after swirling the mixture to re-disperse model soil into water, thereby ensuring that no model soil is inadvertently left behind in the centrifuge tube. The glass petri dish containing the model soil/water mixture is weighed to within ±0.1 mg W_{(Petri Dish+Soil Dispersion)}. The weight of soil dispersion recovered W_{(recovered Soil Dispersion)} is calculated by subtracting the weight of the glass petri dish W_{(Petri Dish)} from the W_{(Petri Dish+Soil Dispersion)}. The glass petri dish is then placed into a vented laboratory drying oven at 105° C. until the sample is residual soil is fully dry. The W_{(Recovered Soil Dispersion)} should be >95% of the W_{(Soil Dispersion)}.

Once the sample is dry, the glass petri dish containing the dried model soil is removed from the oven and placed in a desiccator until cool and then re-weighed to within ±0.1 mg W_{(Petri Dish+Residual Dry Soil)}. The weight of residual soil W_{(Residual Soil)} is calculated by subtracting the weight of the glass petri dish W_{(Petri Dish)} from W_{(Petri Dish+Residual Dry Soil)} and recorded to the nearest 0.2 mg.

### Calculations:

To calculate the amount of residual model soil W_{(Residual Soil)} left in the glass petri dish, the following equation is used:

W_{(Residual Soil)}=W_{(Petri Dish+Residual Dry Soil)}−W_{(Petri Dish)}
Residual model soil weight (W_{(Residual Soil)}) is reported in mg.

To calculate the amount of normalized residual model soil (W_{(Norm Residual Soil)}) left in the glass petri dish, the following equation is used:

W_{(Norm Residual Soil)}=W_{(Residual Soil)}*W_{(Soil Dispersion)}/W_{(Recovered Soil Dispersion)}
Normalized residual soil weight W_{(Norm Residual Soil)} is reported in mg.

To calculate the amount of soil adsorbed by the sample, the following calculation is used:

W_{(Soil Adsorbed)}=(W_{(Soil)}−W_{(Norm Residual Soil)})/W_{(Prod)}
Soil adsorbed in sample W_{(Soil Adsorbed)} is reported as mg soil/g cleaning article.

The test is performed on three replicates and an Average Soil Adsorption Value (Avg W_{(Soil Adsorbed)}) is calculated for the cleaning article. These values are measured and calculated for initial Average Soil Adsorption Value of a specimen prior to subjecting the specimen to the Accelerated and Stress Aging Procedures described herein and after subjecting the specimen to the Accelerated and Stress Aging Procedures described herein. Soil Adsorption Value is also referred to herein as mg Soil Retained/gram Paper and its corresponding % Soil Retained (by Paper).

### Charge Density Test Method

The charge density of a polymer, such as a soil adsorption polymer, can be determined by using a Mutek PCD-04 Particle Charge Detector available from BTG, or equivalent instrument. The following guidelines provided by BTG are used.

Start with a 0.1% solution (0.1 g polymer+99.9 g deionized water) (sample). Depending on the titrant consumption increase or decrease polymer content if needed. Solution pH is adjusted prior to final dilution as charge density of many polymers and/or additives is dependent upon solution pH. A pH of 4.5 is used here.

1. Place 20 mL of sample in the PCD measuring cell and insert piston.

2. Put the measuring cell with piston and sample in the PCD, the electrodes are facing the rear. Slide the cell along the guide until it touches the rear.

3. Pull piston upwards and turn it counter-clock-wise to lock the piston in place.

4. Switch on the motor. The streaming potential is shown on the touch panel. Wait 2 minutes until the signal is stable.

5. Use an oppositely charged titrant (for example for a cationic sample having a positive streaming potential: use an anionic titrant). Titrants are available from BTG consisting of 0.001N PVSK or 0.001N PolyDADMAC.

6. An automatic titrator available from BTG is utilized. After selecting the proper titrant, set the titrator to rinse the tubing by dispensing 10 mL insuring that all air bubbles have been purged.

7. Place tubing tip below the surface of the sample and start titration. The automatic titrator is set to stop automatically when the potential reaches 0 mV.

8. Record consumption of titrant, ideally, the consumption of titrant should be 0.2 mL to 10 mL; otherwise decrease or increase polymer content.

9. Repeat titration of a second 20 mL aliquot of the polymer sample.

10. Calculate charge demand (solution) or charge demand (solids);

$$Charge demand ( eq \text{/} L ) = \frac{V titrant used ( L ) \times Conc . of titrant in Normality ( eq \text{/} L )}{Volume of sample titrated ( L )}$$

$$Charge demand ( eq \text{/} g ) = \frac{V titrant used ( L ) \times Conc . of titrant in Normality ( eq \text{/} L )}{Wt . solids of the sample or its active substance ( g )}$$

The charge demand (charge density) of a polymer is reported in meq/g units.

### Basis Weight Test Method

The rectilinear 3.00 inch×4.00 inch piece of specimen cut as above in the soil adsorption test method is conditioned in a conditioned room at 70° F.±2° F. and a relative humidity of 50%±2% for at least 2 hours, typically overnight. The specimen is weighed to within ±10 mg (Weight_{substrate}) while still maintaining the conditioning conditions. The Basis Weight of the specimen is then calculated as follows:

$$BasisWeight ( gsm ) = ( \frac{{Weight}_{Substarte} ( g )}{3 inch \times 4 inch} ) * {( \frac{inch}{2.54 cm} )}^{2} * {( \frac{100 cm}{m} )}^{2}$$

### Moisture Content Test Method

The moisture content present in an article is measured using the following Moisture Content Test Method.

An article or portion thereof (“sample”) is placed in a conditioned room at a temperature of 73° F.±4° F. (about 23° C.±2.2° C.) and a relative humidity of 50%±10% for at least 24 hours prior to testing. The weight of the sample is recorded when no further weight change is detected for at least a 5 minute period. Record this weight as the “equilibrium weight” of the sample. Next, place the sample in a drying oven for 24 hours at 70° C. with a relative humidity of about 4% to dry the sample. After the 24 hours of drying, remove the sample from the drying oven and immediately weigh the sample. Record this weight as the “dry weight” of the sample. The moisture content of the sample is calculated as follows:

$$\% Moisture in sample = 100 \% \times \frac{( Equilibrium weight of sample - Dry weight of sample )}{Dry weight of sample}$$

The % Moisture in sample for 3 replicates is averaged to give the reported % Moisture in sample.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

For clarity purposes, the total “% wt” values do not exceed 100% wt.

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning article for cleaning a surface, the cleaning article comprising one or more cleaning agents present on a surface of the cleaning article, wherein the cleaning agents comprise one or more film-forming polymers, wherein at least one of the film-forming polymers comprises at least one monomeric unit selected from each of the following groups:
a. nonionic monomeric units;
b. anionic monomeric units; and
c. cationic monomeric units;
such that the cleaning article exhibits an Average Mirror Densitometer Value of greater than −0.55 as measured according to the Mirror Cleaning Test Method after being subjected to Accelerated Aging Procedure.

2. The cleaning article according to claim 1 wherein the nonionic monomeric units comprise a nonionic hydrophilic monomeric unit.

3. The cleaning article according to claim 2 wherein the nonionic hydrophilic monomeric unit is derived from a nonionic hydrophilic monomer selected from the group consisting of: hydroxyalkyl esters of α,β-ethylenically unsaturated acids, α,β-ethylenically unsaturated amides, α,β-ethylenically unsaturated monoalkyl amides, α,β-ethylenically unsaturated dialkyl amides, α,β-ethylenically unsaturated monomers bearing a water-soluble polyoxyalkylene segment of the poly(ethylene oxide) type, α,β-ethylenically unsaturated monomers which are precursors of hydrophilic units or segments, vinylpyrrolidones, α,β-ethylenically unsaturated monomers of the ureido type, and mixtures thereof.

4. The cleaning article according to claim 2 wherein the nonionic hydrophilic monomeric unit is derived from acrylamide.

5. The cleaning article according to claim 1 wherein the nonionic monomeric units comprise a nonionic hydrophobic monomeric unit.

6. The cleaning article according to claim 1 wherein the cationic monomeric unit is derived from (3-methacrylamidopropyl)trimethylammonium chloride.

7. The cleaning article according to claim 1 wherein the cationic monomeric unit is derived from N,N-dimethyldiallylammonium chloride.

8. The cleaning article according to claim 1 wherein the at least one film-forming polymer comprises at least 69.9% wt of a monomeric unit from group a.

9. The cleaning article according to claim 8 wherein the at least one film-forming polymer comprises no more than 30.1% wt of a monomeric unit selected from the group consisting of: group b, group c, and mixtures thereof.

10. The cleaning article according to claim 9 wherein the at least one film-forming polymer comprises at least 69.9% wt of the monomeric unit from group a, no more than 30.1% wt of the monomeric unit from group b and no more than 30.1% wt of the monomeric unit from group c.

11. The cleaning article according to claim 10 wherein the at least one film-forming polymer comprises from about 70% to about 99.5% wt of the monomeric unit from group a, from about 0.1% to about 10% wt of the monomeric unit from group b, and from about 0.3% to about 29% wt of the monomeric unit from group c.

12. The cleaning article according to claim 1 wherein the monomeric unit from group b and the monomeric unit from group c are present in the film-forming polymer at a molar ratio of from about 3:1 to about 1:3.

13. The cleaning article according to claim 1 wherein the at least one film-forming polymer exhibits an excess charge of from about 0 to about 10 meq/g as measured according to the Charge Density Test Method.

14. The cleaning article according to claim 1 wherein the film-forming polymer exhibits a Polydispersity Index of less than about 2.5.

15. The cleaning article according to claim 1 wherein the film-forming polymer is water-soluble.

16. The cleaning article according to claim 1 wherein the cleaning article comprises a fibrous structure.

17. The cleaning article according to claim 16 wherein the fibrous structure comprises a plurality of pulp fibers.

18. The cleaning article according to claim 16 wherein the fibrous structure comprises a sanitary tissue product.

19. The cleaning article according to claim 1 wherein the cleaning article is a dry article.

20. The cleaning article according to claim 1 wherein the cleaning article exhibits a Soil Adsorption Value of greater than 90 mg/g as measured according to the Soil Adsorption Test Method.
